(19) United States
(12) Patent Application Publication
(10) Pub. No.: US 2026/0365204 A1
(43) Pub. Date: Nov. 19, 2026

(54) VEHICLE CONFIGURED TO TRAVEL BY AUTONOMOUS AUTOMATED DRIVING

(71) Applicant: SUBARU CORPORATION, Tokyo (JP)

(72) Inventor: Kentaro SHIGEOKA, Tokyo (JP)

(21) Appl. No.: 19/515,526

(22) PCT Filed: Oct. 3, 2023
(86) PCT No.: PCT/JP2023/036013

§ 371 Date: Mar. 2, 2026

(51) Int. Cl. B60W 60/00; B60W 40/112

(52) U.S. Cl. CPC B60W 60/0015; B60W 40/112; B60W 2520/18; B60W 2530/201; B60W 2552/15; B60W 2552/20; B60W 2552/35; B60W 2556/40

(57) ABSTRACT

A vehicle includes: a travel control device that controls travel of the vehicle by a route decided by itself; a vehicle external sensor that makes observation in a direction of advance of the vehicle; and a travel surface information generation device that generates information regarding a travel surface in the direction of advance of the vehicle. The travel surface information generation device generates, for each minute division, unevenness information regarding the travel surface based on information by the vehicle external sensor or information regarding map data, to generate altitude map data. The travel surface information generation device determines, for each minute division, travelability or of the travel surface, using specification information regarding the vehicle or information regarding a travel state of the vehicle. The travel surface information generation device generates travelability map data in which the information in the altitude map data is replaced with a determination result of the travelability.

### TECHNICAL FIELD

The invention relates to a vehicle configured to travel by autonomous automated driving.

### BACKGROUND ART

Patent Literatures 1 and 2 disclose detecting an obstacle in a direction of advance of a vehicle based on, for example, an overhead view image captured from the vehicle, and obtaining a route to avoid the obstacle.

Patent Literature 3 discloses displaying a three-dimensional model image obtained by capturing an uneven surface of a road surface, with a wire frame indicating unevenness of the road surface superimposed thereon.

### Citation List

### Patent Literature

Patent Literature 1: Japanese Unexamined Patent Application Publication No. 2006-099409

Patent Literature 2: Japanese Unexamined Patent Application Publication No. 2022-104791

Patent Literature 3: Japanese Unexamined Patent Application Publication No. 2018-056953

### SUMMARY OF INVENTION

### Problem to be Solved by the Invention

Meanwhile, in a vehicle such as an automobile, development has been in progress, to assist a driver in driving, or to travel by autonomous automated driving without depending on driving by the driver.

Moreover, development of technology has been in progress, for a vehicle to travel along a lane of a road on a predetermined developed road.

However, a vehicle does not travel only on a lane of a developed road as in Patent Literatures 1 and 2.

For example, as in Patent Literature 3, a vehicle sometimes travels on an undeveloped road having an uneven surface.

Furthermore, a vehicle does not only travel along a lane of a road on a predetermined developed road.

For example, there is possibility that a vehicle travels from a lane of a developed road to a parking lot, etc. of a store next to the road. Moreover, a curbstone is sometimes provided between the road or the lane on which the vehicle is traveling and the parking lot. In this case, depending on a height of the curbstone, there is possibility that the vehicle has difficulties in traveling toward the parking lot to pass across the curbstone.

In addition, when an emergency or the like occurs in a vehicle, it is desired that the traveling vehicle move to a road shoulder of a road and be stopped on the road shoulder. In this case, the vehicle needs to be stopped on a safe road shoulder without unevenness.

As described, as to a vehicle configured to travel by autonomous automated driving, an improvement is desired to allow the subject vehicle as a traveling vehicle to decide a route of the vehicle while securing a stable posture.

### Means for Solving the Problem

A vehicle configured to travel by autonomous automated driving according to an aspect of the invention includes: a travel control device configured to control travel of the vehicle by deciding a route to be traveled by the autonomous automated driving and controlling the travel of the vehicle by the decided route; a vehicle external sensor provided in the vehicle and configured to make observation in a direction of advance of the vehicle; and a travel surface information generation device for the vehicle. The travel surface information generation device is configured to generate information regarding a travel surface in the direction of advance of the vehicle, using one or both of information by the vehicle external sensor and information regarding map data acquirable for the vehicle. The travel surface information generation device is configured to perform acquisition processing of acquiring the information by the vehicle external sensor and the information regarding the map data, altitude map generation processing of generating, for each minute division, unevenness information regarding the travel surface in the direction of advance based on the information acquired in the acquisition processing, to generate altitude map data including the unevenness information for each minute division regarding the travel surface in the direction of advance, from the generated unevenness information regarding the travel surface, determination processing of determining, with respect to the unevenness information for each minute division included in the altitude map data, travelability or untravelability for the vehicle of the travel surface regarding which the unevenness information regarding the travel surface is generated for each minute division in the altitude map generation processing, using one or both of specification information regarding the vehicle and information regarding a travel state of the vehicle, and travelability map generation processing of generating, based on a determination result of the determination processing, travelability map data in which the unevenness information for each minute division in the altitude map data is replaced with the determination result of the travelability or the untravelability for each minute division. The travel control device is configured to decide the route to travel on the travel surface in the direction of advance, to allow the vehicle to travel while giving priority to whichever minute division is considered to be travelable in the travelability map data over whichever minute division is considered to be untravelable in the travelability map data, to control the travel of the vehicle by the decided route.

### EFFECTS OF THE INVENTION

In the invention, together with the travel control device, the travel surface information generation device is provided. The travel control device is configured to control the travel of the vehicle. The surface information generation device generates the information regarding the travel surface in the direction of advance of the vehicle. This saves the travel control device from performing processing of generating the information regarding the travel surface. It is possible for the travel control device to decide the route of the vehicle, on very short cycles, based on the latest information at each time point, to cope with travel environment of the vehicle that changes every moment in accordance with the travel, etc., and allow the vehicle to travel by the decided route.

Moreover, the travel surface information generation device of the invention acquires one or both of the information by the vehicle external sensor and the information regarding the map data acquirable for the vehicle, and generates the altitude map data based on the acquired information. In this altitude map data generation processing, the travel surface information generation device generates, for each minute division, the unevenness information in the direction of advance, and generates, from the generated unevenness information, the altitude map data including the unevenness information for each minute division regarding the travel surface in the direction of advance.

Furthermore, the travel surface information generation device determines, with respect to the unevenness information regarding the travel surface for each minute division included in the altitude map data generated in the altitude map generation processing, the travelability or the untravelability of the travel surface for the vehicle, using one or both of the specification information regarding the vehicle and the information regarding the travel state of the vehicle. In addition, based on the determination result of the determination processing, the travel surface information generation device generates the travelability map data in which the unevenness information for each minute division in the altitude map data is replaced with the determination result of the travelability or the untravelability for each minute division.

This helps the travel control device to acquire the travelability map data including the determination result made in advance with respect to the current travel, etc. of the vehicle, and decide the route to travel on the travel surface in the direction of advance. The travel control device selects the route to allow the vehicle to travel while giving priority to whichever minute division is considered to be travelable in the travelability map data over whichever minute division is considered to be untravelable in the travelability map data. This makes it possible to decide the route to travel along a travelable route, by easy and time-saving processing.

In addition, to generate the travelability map data, the travel surface information generation device, first, divides the travel surface of the vehicle including the road surface to be actually traveled by the vehicle into the minute divisions, to generate the altitude map data including the unevenness information for each minute division. The travel surface information generation device is configured to generate, in a short time, the altitude map data including the unevenness information that covers the travel surface, by finite processes in which the travel surface is quantized for each minute division.

Moreover, the travel surface information generation device determines the travelability or the untravelability for the vehicle, for each minute division in the altitude map data. Thus, the travel surface information generation device generates the travelability map data in which the unevenness information for each minute division in the altitude map data is replaced with the determination result of the travelability or the untravelability for each minute division. It is possible for the travel surface information generation device to generate the travelability map data in a short time as well.

As described, it is possible for the travel surface information generation device to generate the travelability map data and keep on updating the travelability map data by the series of processes to be finished in a short time. It is possible for the travel surface information generation device to keep on updating the travelability map data, to be able to correspond to control cycles of the travel control device.

In contrast, for example, if the altitude map data is not quantized for each minute division, the travel surface information generation device and the travel control device determine the travelability or the untravelability of a selected route. Thus, when the selected route is untravelable, the travel surface information generation device and the travel control device select a new route and repeat the processing. In such loop processing, it is unclear how long it takes to decide a final route available for a travel control. When assuming that it is necessary to perform the travel control on short cycles, there is possibility that the series of processes are not established but end in failure.

As a result, in the invention, the travelability or the untravelability with respect to the unevenness of the travel surface to be traveled by the vehicle is determined in advance by the travel surface information generation device. This helps the travel control device of the vehicle to decide the route in accordance with the determination result of the travelability or the untravelability. The vehicle of the invention makes it possible to decide the route and travel, to cope with, for example, an undeveloped road with an uneven surface, unevenness by a curbstone of a road on which the vehicle is traveling, and to make a stop on a safe road shoulder without unevenness, etc.

As described, in the invention, it is possible to improve a control system of a vehicle, to allow the subject vehicle as a traveling vehicle to decide a route of the vehicle while ensuring a stable posture.

### BRIEF DESCRIPTION OF DRAWINGS

FIG. 1 is a diagram of an automobile configured to travel by autonomous automated driving according to a first embodiment of the invention traveling on a lane of a developed paved road.

FIG. 2 is a diagram of the automobile in FIG. 1 traveling on an undeveloped road including an uneven road surface.

FIG. 3 is an illustrative diagram of a limitation characteristic with respect to a roll inclination of an automobile.

FIG. 4 is an illustrative diagram of a main configuration of a control system of the automobile in FIG. 1.

FIG. 5 is an illustrative diagram of an example of main functions to be realized in a travel surface information generation device in FIG. 4.

FIG. 6 is an illustrative diagram of altitude map data regarding an undeveloped road including an uneven road surface in the road in FIG. 2.

FIG. 7 is an illustrative diagram of a grounding state with the travel surface, of the automobile in FIG. 1.

FIG. 8 is an illustrative diagram of virtual routes in the embodiment.

FIG. 9 is an illustrative diagram of a travel state of the automobile when steering to the left when traveling.

FIG. 10 is an illustrative diagram of a G-G characteristic of the automobile in FIG. 1.

FIG. 11 is an illustrative diagram of travelability map data regarding the undeveloped road including the uneven road surface in FIG. 2.

FIG. 12 is an illustrative diagram of the travelability map data regarding the developed paved road in FIG. 1.

FIG. 13 is a flowchart of a travel surface information generation control by the travel surface information generation device in FIGS. 4 and 5.

FIG. 14 is a flowchart of a travel control of the automobile by a travel control device in FIG. 4.

FIG. 15 is an illustrative diagram of virtual routes in a third embodiment of the invention.

FIG. 16 is an illustrative diagram of an example of a rollover determination in a minute division by the virtual route in FIG. 15.

FIG. 17 is an illustrative diagram of the travelability map data generated based on a determination as being untravelable only when untravelable on both right and left, with wheel positions as a standard as in the embodiment.

FIG. 18 is an illustrative diagram of travelability map data according to a comparative example generated based on a determination as being untravelable when untravelable on either right or left, with the wheel positions as the standard unlike the embodiment.

FIG. 19 is an illustrative diagram of travelability map data according to another comparative example generated based on a determination as being untravelable when untravelable on either right or left, with the horizontal center of a vehicle body as the standard unlike the embodiment.

FIG. 20 is an illustrative diagram of travelability map data generated based on a determination as being untravelable only when untravelable on both right and left, with the wheel positions as the standard as in the embodiment.

### MODES FOR CARRYING OUT THE INVENTION

In the following, some embodiments of the invention are described with reference to the drawings.

### First Embodiment

FIG. 1 is a diagram of an automobile 1 configured to travel by autonomous automated driving according to a first embodiment of the invention traveling on a lane of a developed paved road 2. The automobile 1 is an example of a vehicle.

In FIG. 1, the automobile 1 is traveling from the left to the right in the figure, on a lane 3 of the paved road 2 including one lane on each side. In this case, the automobile 1 keeps on traveling straight on the lane 3 on which the automobile 1 is traveling, or travels toward parking spaces P1 and P2 of a store 7 next to the paved road 2. It is to be noted that the paved road 2 includes an opposite lane 4 and a sidewalk 5 in addition to the lane 3.

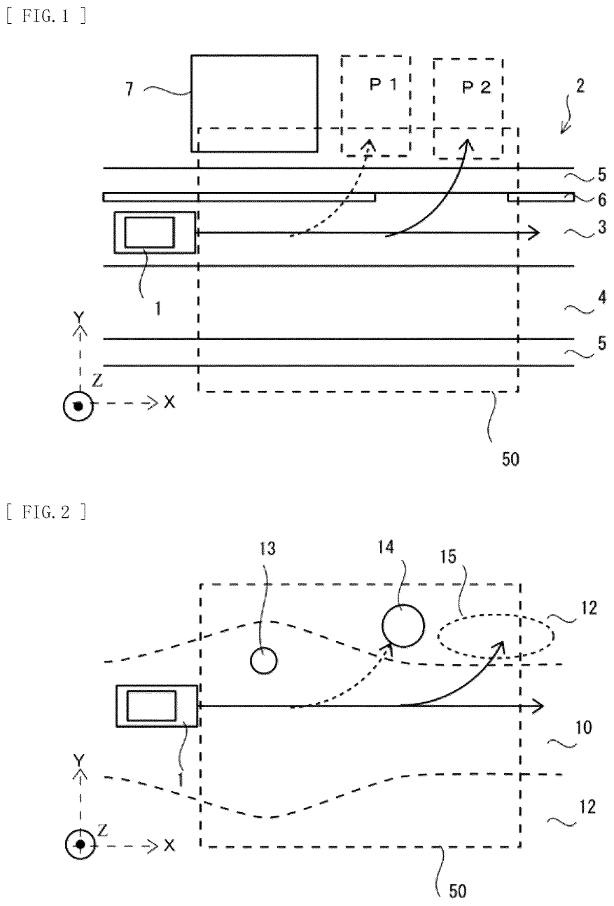

FIG. 2 is a diagram of the automobile 1 in FIG. 1 traveling on an undeveloped road 10 including an uneven road surface. In this case, the automobile 1 keeps on traveling straight on the road 10 on which the automobile 1 is traveling, or travels to stop in a space 15 available for parking beside the road.

When making these travels by the autonomous automated driving, a control system 20 of the automobile 1 has to repetitively decide a route to travel in a direction of advance of the automobile 1 on very short cycles, and control the travel of the automobile 1 to allow the automobile 1 to travel along the decided route in each cycle. Making the cycle of decision of the route very short makes it possible to travel in accordance with a situation of a travel surface that changes every moment. Conceivably, for example, it is possible for the automobile 1 configured to travel by the autonomous automated driving to travel to avoid a stone 13 on the road surface in FIG. 2.

It is to be noted that, as illustrated in FIGS. 1 and 2, in the embodiment, the direction of advance of the automobile 1 is defined as an X-axis, a direction straight to the X-axis in the travel surface is defined as a Y-axis, and a direction perpendicular to the travel surface is defined as a Z-axis.

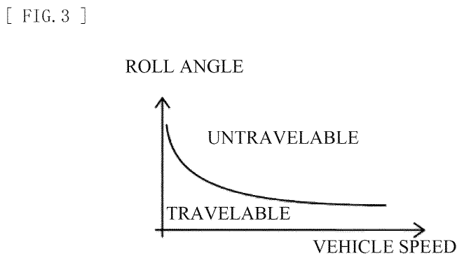

FIG. 3 is an illustrative diagram of a limitation characteristic with respect to a roll inclination of the automobile 1.

The horizontal axis in FIG. 3 denotes a vehicle speed as a speed of the automobile 1. The vertical axis is a roll angle indicating a roll inclination of the automobile 1 in a vehicle widthwise direction. FIG. 3 illustrates a roll limitation characteristic curve of the automobile 1.

The automobile 1 has a roll limit angle with respect to the roll angle in the vehicle widthwise direction, because of its travel performance, as indicated by the roll limit characteristic curve in FIG. 3. When rolling beyond the roll limit angle, the automobile 1 rolls over by an overturn.

Moreover, the roll limit angle of the automobile 1 varies with the vehicle speed. When the vehicle speed is low, the roll limit angle becomes larger. When the vehicle speed is high, the roll limit angle becomes smaller.

As to the automobile 1 configured to travel by the autonomous automated driving, it is necessary to control the travel of the automobile 1, to prevent the automobile 1 from traveling beyond the roll limit angle.

For example, the automobile 1 does not travel only on the developed paved road 2, as illustrated in FIG. 1. As illustrated in FIG. 2, the automobile 1 sometimes travels on the undeveloped road 10 including the uneven surface.

Moreover, as illustrated in FIG. 1, the automobile 1 sometimes travels from the lane 3 of the developed paved road 2 toward the parking spaces P1 and P2 or the like of the store 7 next to the paved road 2. In FIG. 1, a curbstone 6 is provided between the lane 3 on which the automobile 1 is traveling and the sidewalk 5 of the paved road 2. Depending on a height of the curbstone 6, there is possibility that the automobile 1 has difficulties in traveling to pass across the curbstone 6 toward the parking spaces P1 and P2. In this case, the automobile 1 configured to travel by the autonomous automated driving has to travel toward the second parking space P2 rather than the first parking space P1, not to run aground on the high curbstone 6.

Furthermore, when an emergency or the like occurs in the automobile 1, it is desired that the automobile 1 traveling by the autonomous automated driving move to a road shoulder of a road and be stopped on the road shoulder. In this case, as illustrated in FIG. 2, the automobile 1 has to travel to be stopped in the flat space 15 available for parking without a standing tree 14 or the like, in a roadside space 12.

As described, with respect to the automobile 1 configured to travel by the autonomous automated driving, improvement is desired to allow the subject vehicle as the traveling vehicle to decide the route of the vehicle while ensuring a stable posture.

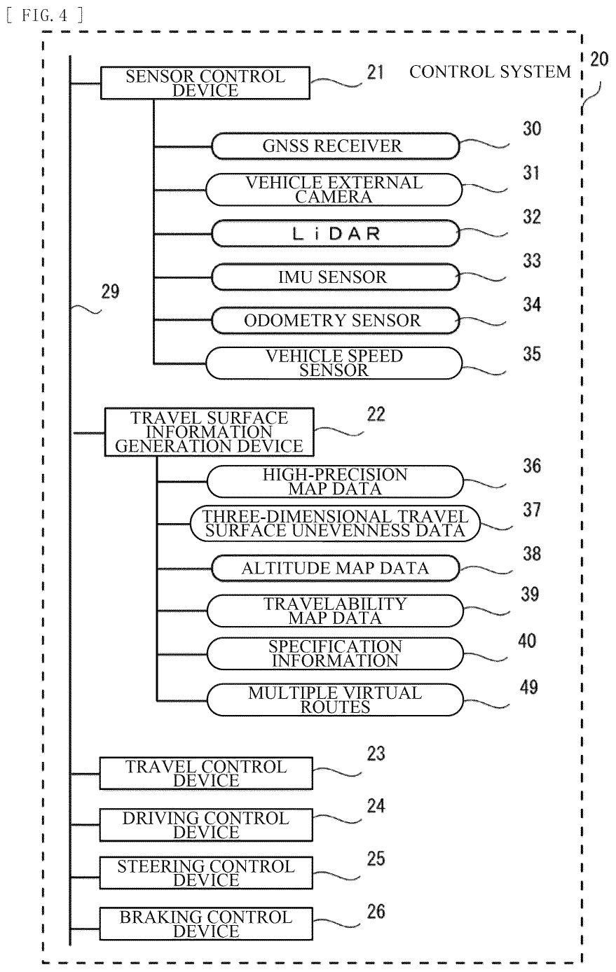

FIG. 4 is an illustrative diagram of a main configuration of the control system 20 of the automobile 1 in FIG. 1.

The control system 20 of the automobile 1 in FIG. 4 includes a vehicle network 29 and control devices coupled thereto. In FIG. 4, as examples of the control devices, a sensor control device 21, a travel control device 23, a travel surface information generation device 22 separate from the travel control device 23, a driving control device 24, a steering control device 25, and a braking control device 26 are illustrated.

It is to be noted that, for example, an operation control device, a vehicle external communication device, or the like may be coupled to the vehicle network 29 as other control devices than those illustrated in FIG. 4. To the operation control device, operation members such as a steering wheel or a pedal may be coupled. The operation members are to be operated by an occupant during manual driving. Moreover, the various control devices illustrated in FIG. 4 may be divided into devices and coupled to the vehicle network 29, or alternatively, devices may be integrated and coupled to the vehicle network 29.

The vehicle network 29 may be one for vehicles such as a CAN (Controller Area Network) or a LIN (Local Interconnect Network). Moreover, the vehicle network 29 may be a network based on IEEE (Institute of Electrical and Electronics Engineers) 802.3 or its derivative standard. The control devices provided in the automobile 1 are configured to input and output information to and from each other through the vehicle network 29.

To the sensor control device 21, various subject-vehicle sensors provided in the automobile 1 are coupled. The sensor control device 21 controls operation of the subject-vehicle sensors, and outputs information regarding detection values by the subject-vehicle sensors or information obtained by processing the detection values, to other control devices through the vehicle network 29.

FIG. 4 illustrates a GNSS (Global Navigation Satellite System) receiver 30, a vehicle external camera 31, LiDAR 32, an IMU (Inertial Measurement Unit) sensor 33, an odometry sensor 34, and a vehicle speed sensor 35 as examples of the subject-vehicle sensors coupled to the sensor control device 21. In addition, a steering sensor, etc. may be coupled to the sensor control device 21. The steering sensor detects a steering wheel angle of the unillustrated steering wheel of the automobile 1.

The GNSS receiver 30 receives radio waves of GNSS satellites and generates information regarding a position of the automobile 1 and the time.

The vehicle external camera 31 captures an image of surroundings of the automobile 1 including a frontward direction of the automobile 1 traveling on a road or the like. The vehicle external camera 31 may be a monocular camera, a compound-eye camera, or a 360-degree camera. The sensor control device 21 may generate, based on the captured image by the vehicle external camera 31, information regarding relative distances and relative directions with respect to other moving objects around the subject vehicle, structures such as the curbstone 6, vegetation such as the standing tree 14, and the like. The captured image by the vehicle external camera 31 may include the curbstone 6 in FIG. 1, the stone 13 and the standing tree 14 in FIG. 2, and the unevenness of the travel surface, and the like, as image components.

The LiDAR 32 scans, using a laser, the frontward direction of the automobile 1 traveling on a road or the like, and generates three-dimensional spatial information in the direction of advance of the automobile 1. When there are other moving bodies, structures such as the curbstone 6, and the vegetation such as the standing tree 14 around the subject vehicle, the laser is reflected by them. The curbstone 6 in FIG. 1, the stone 13 and the standing tree 14 in FIG. 2, and the unevenness on the travel surface are configured to reflect the laser. Based on presence or absence of reflected waves of the laser, TOF (Time Of Flight), and the like, the LiDAR 32 may generate the three-dimensional spatial information in the direction of advance of the automobile 1 based on the reflected waves.

The vehicle external camera 31 and the LiDAR 32 are vehicle external sensors that are provided in the automobile 1 and make observation in the direction of advance of the automobile 1.

The IMU sensor 33 detects translational motions and rotational motions of the automobile 1 in straight triaxial directions, basically using an acceleration rate sensor and a gyro sensor. The IMU sensor 33 may detect angular velocities and angles in a roll direction, a pitch direction, and a yaw direction of the automobile 1.

The odometry sensor 34 detects a distance of movement of the automobile 1, a position after the movement, and the like based on rotation angles of wheels of the automobile 1.

The vehicle speed sensor 35 detects the speed of the automobile 1. The vehicle speed sensor 35 may detect the speeds of the automobile 1 in a longitudinal direction, the vehicle widthwise direction, and a vertical direction.

The travel surface information generation device 22 generates information regarding the travel surface in the direction of advance of the automobile 1. The information regarding the travel surface in the direction of advance of the automobile 1 may include information regarding not only the travel surface of the lane or the road on which the automobile 1 is traveling but also a surface around the lane or the road.

The travel surface information generation device 22 includes an unillustrated CPU (Central Processing Unit) and an unillustrated memory. As illustrated in FIG. 4, the memory may hold a program together with high-precision map data 36, three-dimensional travel surface unevenness data 37, altitude map data 38, travelability map data 39, specification information 40 regarding the automobile 1, virtual routes 49, and the like. The CPU reads the program from the memory and executes the program. Thus, the CPU serves as a controller of the travel surface information generation device 22. The three-dimensional travel surface unevenness data 37, the altitude map data 38, and the travelability map data 39 are information to be generated by the CPU of the travel surface information generation device 22 in travel surface information generation processing.

The high-precision map data 36 includes road data regarding mainly the paved road 2. As information regarding each road, the high-precision map data 36 basically includes information regarding, for example, presence or absence of a sidewalk of a road, a shape of a road, a centerline of each lane, coupling of roads and intersections, traffic lights, and a stop line. Moreover, the high-precision map data 36 may include, for example, unevenness information regarding a structure provided on the road surface such as the curbstone 6 that partitions the lane and the sidewalk, together with unevenness information regarding the road surface itself.

Furthermore, in addition to the road data, the high-precision map data 36 may include information regarding positions of the store 7 next to the road, the parking spaces P1 and P2 of the store 7, and the like. By using such high-precision map data 36, the automobile 1 configured to travel autonomously by automated driving is configured to travel by the automated driving, for example, from the lane toward the parking spaces P1 and P2 of the store 7.

The specification information 40 regarding the automobile 1 includes, for example, information regarding a size and a weight of the automobile 1. The specification information 40 may also include, for example, information regarding the number of the wheels, sizes of the wheels, and positions of the wheels of the automobile 1.

The three-dimensional travel surface unevenness data 37 includes unevenness information regarding the travel surface including the road surface in the direction of advance of the automobile 1. For example, upon acquiring the information regarding the curbstone 6 on the travel surface from the high-precision map data 36, the CPU of the travel surface information generation device 22 maps the unevenness information regarding the curbstone 6 onto the travel surface, based on positional information in the high-precision map data 36. Moreover, when the captured image by, for example, the vehicle external camera 31 as the vehicle external sensor includes other moving bodies, a structure such as the curbstone 6, and the vegetation such as the standing tree 14, the CPU of the travel surface information generation device 22 maps the unevenness information onto the travel surface, based on the information regarding the relative distances and the relative directions from the subject vehicle.

Thus, the three-dimensional travel surface unevenness data 37 includes the unevenness information regarding the travel surface in the direction of advance of the automobile 1.

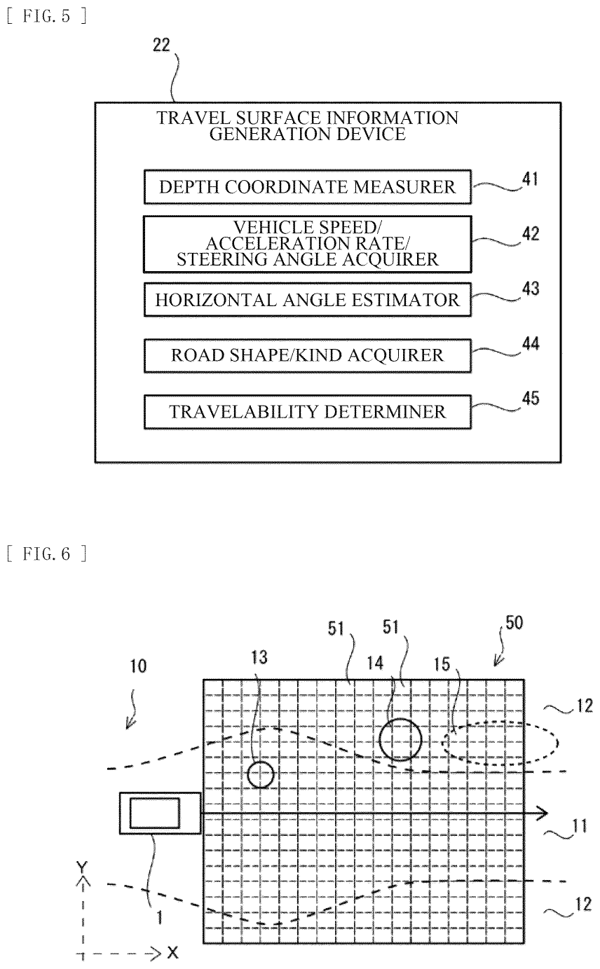

The altitude map data 38 includes the unevenness information regarding a predetermined range in the travel surface in the direction of advance in the three-dimensional travel surface unevenness data 37. As illustrated in FIG. 6 described later, the altitude map data 38 divides the travel surface of the predetermined range 50 in the direction of advance into minute divisions 51, and includes unevenness information for each minute division 51.

In the altitude map data 38, the unevenness information regarding the travel surface in the direction of advance is quantized for each minute division 51, and may have a finite amount of information.

As the unevenness information regarding each minute division 51, the CPU of the travel surface information generation device 22 may use a value of the largest unevenness in the relevant minute division 51. Thus, the unevenness information regarding, for example, the minute division 51 including the curbstone 6 may be a height of projection of the curbstone 6 from the travel surface.

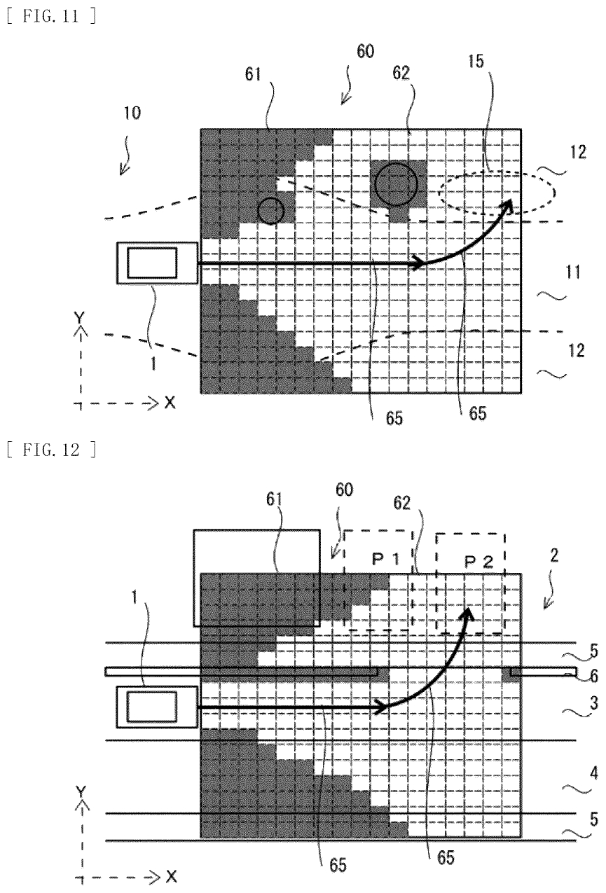

As illustrated in FIG. 11 or 12 described later, the travelability map data 39 is that in which the unevenness information in the altitude map data 38 is replaced with a determination result of travelability or untravelability for each minute division 51.

The CPU of the travel surface information generation device 22 determines presence or absence of possibility of a rollover such as an overturn, when the automobile 1 travels through each minute division 51 in the altitude map data 38. Moreover, in a case with the presence of the possibility of the rollover, the CPU of the travel surface information generation device 22 determines that the relevant minute division 51 is untravelable, and replaces the unevenness information regarding the relevant minute division 51 with untravelability information. Thus, the travelability map data 39 includes information regarding the determination result of the travelability or the untravelability of a predetermined range 60 in the travel surface in the direction of advance.

In a case with the absence of the possibility of the rollover, the CPU of the travel surface information generation device 22 determines that the relevant minute division 51 is travelable, and replaces the unevenness information regarding the relevant minute division 51 with travelability information. In FIGS. 11 and 12, untravelable minute divisions 61 are hatched. In contrast, travelable minute divisions 62 are unhatched.

As described later, the virtual routes 49 are routes each of which is a combination of the minute divisions 51 to be traveled through in the altitude map data 38.

To the driving control device 24, driving system members provided in the automobile 1, e.g., an engine, a motor, and a transmission, are coupled. The engine generates a driving force using, for example, gasoline or hydrogen as fuel. The motor generates the driving force by electric power. The driving control device 24 controls operation of these driving system members by control values acquired through the vehicle network 29.

To the steering control device 25, for example, a steering device provided in the automobile 1 is coupled. The steering control device 25 controls operation of the steering device by the control values acquired through the vehicle network 29.

To the braking control device 26, a brake device provided in the automobile 1 is coupled. The braking control device 26 controls operation of the brake device by the control values acquired through the vehicle network 29.

Basically, the travel control device 23 may be any device that decides the route to be traveled by the autonomous automated driving and controls the travel of the automobile 1 by the decided route. The travel control device 23 may be also configured to switch a travel control of the subject vehicle by a manual operation by the driver of the automobile 1, the autonomous automated driving without the manual operation, or automated driving under the control of a server device.

In the case of the autonomous automated driving, the travel control device 23 acquires information regarding a travel state of the subject vehicle and information regarding the surroundings of the subject vehicle from the travel surface information generation device 22 and the sensor control device 21, generates the control values in accordance with these pieces of information, and outputs the control values to the driving control device 24, the steering control device 25, and the braking control device 26.

In the case of the automated driving under the control, the travel control device 23 generates the control values in accordance with the latest individual control information received and acquired from the server device, and outputs the control values to the driving control device 24, the steering control device 25, and the braking control device 26.

In the case of the manual driving, the travel control device 23 acquires information regarding the unillustrated operation control device and the information regarding the surroundings of the subject vehicle, generates the control values in accordance with these pieces of information, and outputs the control values to the driving control device 24, the steering control device 25, and the braking control device 26.

Thus, the automobile 1 is configured to travel by the autonomous automated driving or the like under the control of the travel control device 23.

FIG. 5 is an illustrative diagram of an example of main functions to be realized in the travel surface information generation device 22 in FIG. 4.

In the travel surface information generation device 22 in FIG. 5, as the main functions of the CPU as the controller, a depth coordinate measurer 41, a vehicle speed/acceleration rate/steering angle acquirer 42, a horizontal angle estimator 43, a road shape/kind acquirer 44, and a travelability determiner 45 are realized.

The depth coordinate measurer 41 measures, for example, unevenness and heights of the travel surface in a bird's view (XY plane), positions, ranges, and heights of unevenness caused by dynamic/static obstacles, and the like based on detection results of in-vehicle sensors provided in the automobile 1 such as the LiDAR 32 or the vehicle external camera 31. Here, the bird's view may include omission of information such as point cloud data or a grid map.

The vehicle speed/acceleration rate/steering angle acquirer 42 acquires the information regarding the travel state of the automobile 1 such as the current speed/acceleration rate/steering angle of the automobile 1, from, for example, the odometry sensor 34 or the IMU sensor 33 of the subject vehicle.

The horizontal angle estimator 43 estimates, for example, a pitch angle and a roll angle of the stable automobile 1 as a reference of the automobile 1. At this occasion, the horizontal angle estimator 43 may estimate the pitch angle and the roll angle of the automobile 1 based on a detection value of an unillustrated tilt sensor or the IMU sensor 33. Alternatively, the horizontal angle estimator 43 may acquire an angle of a cant and the like of the travel surface of the roads 2 and 10 included in the high-precision map data 36 and on which the vehicle is traveling, and estimate the pitch angle and the roll angle of the automobile 1 based on the information.

The road shape/kind acquirer 44 acquires, for example, information regarding traffic regulations such as information regarding travelable/untravelable regions and information regarding an upper limit speed from the high-precision map data 36. At this occasion, the road shape/kind acquirer 44 may acquire, for example, the information regarding the upper limit speed in a bird's view format viewed from a vehicle coordinate system, and acquire the information as traffic regulation mapping data.

The travelability determiner 45 determines, for example, a region to be stably traveled by the automobile 1, with respect to the travel surface in the predetermined range 50 in the altitude map data 38 based on the size, a shape, and the speed/steering angle of the automobile 1.

The travelability determiner 45 calculates, for example, a posture of the automobile 1 when traveling on the travel surface in the predetermined range 50 in the altitude map data 38 by a virtual route until X seconds after. The virtual route until X seconds after is generated based on the current speed and the current steering angle of the automobile 1. It is to be noted that the current speed and the current steering angle may have a certain margin.

Moreover, for example, the travelability determiner 45 may make a determination of the untravelability when the posture of the automobile 1 on the virtual route exceeds a dynamic overturn limit angle or a static overturn limit angle of the automobile 1, or when the acceleration rate of the automobile 1 on the virtual route exceeds a rollover limit lateral acceleration rate of the automobile 1.

FIG. 6 is an illustrative diagram of the altitude map data 38 regarding the undeveloped road 10 including the uneven road surface in the road in FIG. 2.

First, the travel surface information generation device 22 maps, for example, the unevenness of the travel surface and unevenness caused by an obstacle or the like obtained by processing as the depth coordinate measurer 41, and the unevenness of the travel surface obtained from the high-precision map data 36, onto the three-dimensional travel surface unevenness data 37. Onto the three-dimensional travel surface unevenness data 37, information regarding the unevenness of the travel surface and the unevenness caused by the obstacle or the like may be mapped as it is.

Next, as illustrated in FIG. 6, the travel surface information generation device 22 associates the minute divisions 51 with the predetermined range 50 in the travel surface in the three-dimensional travel surface unevenness data 37, and generates the altitude map data 38 including the unevenness information for each minute division 51.

Here, as illustrated in FIG. 6, the altitude map data 38 corresponds to the predetermined range 50 of the travel surface in the direction of advance of the automobile 1. The travel surface information generation device 22 sets the predetermined range 50 on side in the direction of advance with respect to the latest position of the automobile 1, with reference to the latest position and the direction of advance of the automobile 1, to allow the latest position of the automobile 1 to assume the middle of one side of the predetermined range 50. Thus, the predetermined range 50 may be set on the side in the direction of advance of the automobile 1 in the travel surface in the three-dimensional travel surface unevenness data 37.

Moreover, in the generated altitude map data 38, the predetermined range 50 of the travel surface is divided into the minute divisions 51, to include the unevenness information for each of the minute divisions 51.

Here, the travel surface information generation device 22 may select a maximum value of a size of the unevenness of each minute division 51 in the three-dimensional travel surface unevenness data 37, and set the maximum value as the unevenness information regarding the relevant minute division 51.

For example, in the case in FIG. 6, in the minute division 51 including the stone 13 on the road, a height of the stone 13 serves as the maximum value of the size of the unevenness of the relevant minute division 51. In this case, the travel surface information generation device 22 may set the height of the stone 13 as the unevenness information regarding the minute division 51.

Moreover, in the minute division 51 including the standing tree 14 in FIG. 6, a height of the standing tree 14 serves as the maximum value of the size of the unevenness of the relevant minute division 51. In this case, the travel surface information generation device 22 may set the height of the standing tree 14 as the unevenness information regarding the minute division 51.

Furthermore, in the minute division 51 including the roadside space 12 in FIG. 6, a height of the unevenness of the travel surface itself of the relevant space serves as the maximum value of the unevenness of the relevant minute division 51. In this case, the travel surface information generation device 22 may set the height of the unevenness of the travel surface itself as the unevenness information regarding the minute division 51.

In this way, the travel surface information generation device 22 generates the unevenness information regarding the travel surface in the direction of advance, for each minute division 51.

Moreover, the travel surface information generation device 22 generates the altitude map data 38 including the unevenness information for each minute division 51 regarding the travel surface in the direction of advance, from the generated unevenness information regarding the travel surface.

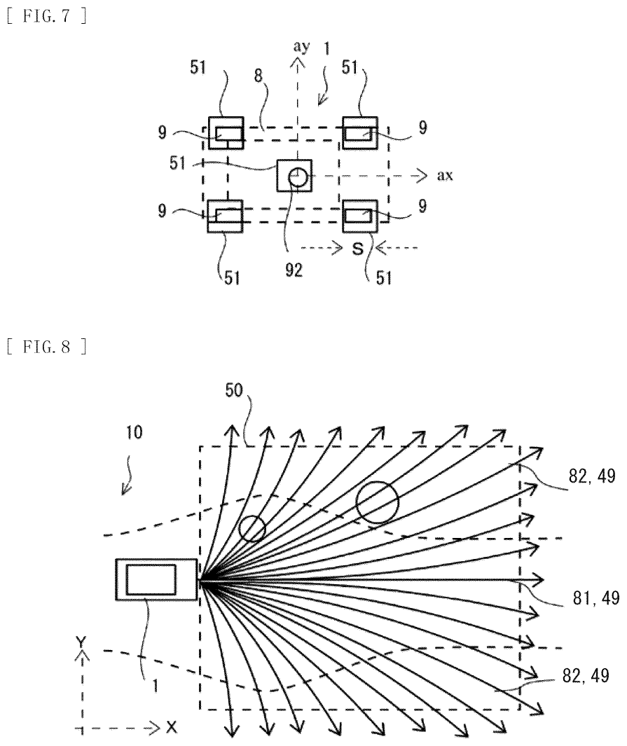

FIG. 7 is an illustrative diagram of a grounding state with the travel surface, of the automobile 1 in Fig. 1.

FIG. 7 illustrates a vehicle body 8 of the automobile 1 and four wheels 9 on right front, left front, right rear, and left rear sides of the vehicle body 8. The automobile 1 is in contact with the travel surface at the four wheels 9.

Moreover, in the embodiment, the minute divisions 51 overlapping with the wheels 9 are illustrated.

Thus, the minute division 51 may be sized as a rectangle with a side S several tens of centimeters, to be larger than a size of the wheel 9 or a ground plane of the wheel 9. This makes it possible to use a combination of heights of the minute divisions 51 on which the four wheels 9 of the automobile 1 are placed, to calculate the posture of the automobile 1. However, if, unlike FIG. 7, the size of the minute division 51 is assumed to be, for example, a rectangle with a side several meters, it is difficult to calculate the posture of the automobile 1 based on the unevenness information regarding the minute divisions 51.

Moreover, the size of the minute division 51 may be smaller than at least a size of the vehicle body 8 of the automobile 1 divided by the number of the wheels 9 of the automobile 1. In FIG. 7, the minute division 51 may be smaller than a size of one quarter of the vehicle body 8 quadrisected longitudinally and laterally. This allows only one wheel 9 of the automobile 1 to be present in each minute division 51. It is possible to calculate the posture of the automobile 1 based on the unevenness information regarding the minute divisions 51 on which the wheels 9 of the automobile 1 are placed.

FIG. 8 is an illustrative diagram of the virtual routes 49 in the embodiment.

In FIG. 8, the undeveloped road 10 including the uneven road surface in the road in FIG. 2 is illustrated in a superimposed manner.

The travel surface information generation device 22 uses the virtual routes 49 to travel on the travel surface included in the altitude map data 38, to determine whether the travel surface indicated by the altitude map data 38 is travelable for the automobile 1. The virtual routes 49 may be held in the travel surface information generation device 22.

The virtual routes 49 in FIG. 8 include a virtual straight route 81 that allows the automobile 1 to travel straight along the route, and virtual steering routes 82 that allow the automobile 1 to steer to the left or to the right from the virtual straight route 81.

In this case, first, the travel surface information generation device 22 may generate, based on the travel state of the automobile 1, the virtual straight route 81 that allows the automobile 1 to travel straight along the route in the travel state as it is. Next, the travel surface information generation device 22 may generate the virtual steering routes 82 that allow the automobile 1 to steer to the left from the virtual straight route 81, and the virtual steering routes 82 that allow the automobile 1 to steer to the right from the virtual straight route 81.

It is to be noted that the virtual routes 49 may not exactly coincide with a route on which the automobile 1 is able to travel by its performance.

Accordingly, each virtual route may be generated assuming that, for example, the latest travel state of the automobile 1 is considered as an initial value, and the vehicle travels after the initial value with constant steering without a slip, or travels with constant acceleration/deceleration without a slip.

Moreover, each virtual steering route 82 may be a route curved at a constant curvature.

Furthermore, the virtual routes 49 in FIG. 8 are basically combinations that allow the vehicle to travel through all the minute divisions 51 in the altitude map data 38 in FIG. 6. It is to be noted that the virtual routes 49 may be those which allow the vehicle to travel through almost all the minute divisions 51 in the altitude map data 38.

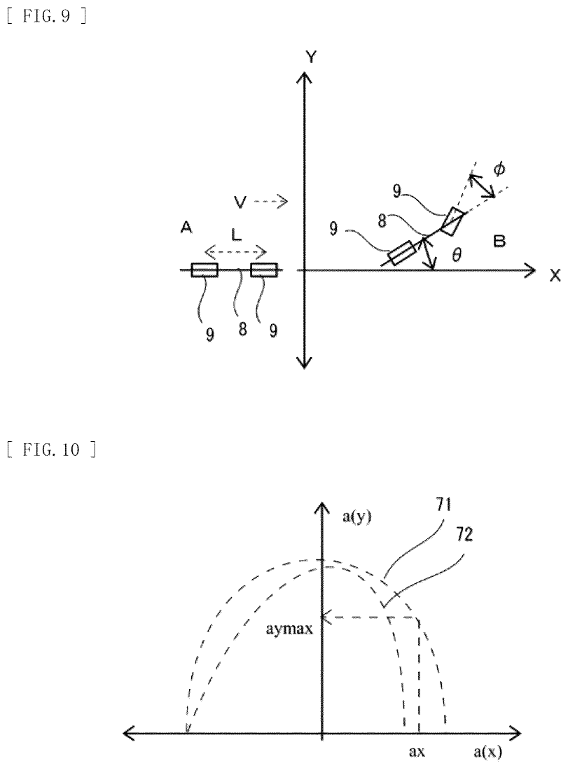

FIG. 9 is an illustrative diagram of the travel state of the automobile 1 when steering to the left while traveling.

In FIG. 9, the automobile 1 is illustrated by a straight line indicating the vehicle body 8 and the front and rear wheels 9.

Moreover, when steering to the left while traveling along the X-axis from a position A on the left side in FIG. 9, a position of the automobile 1 becomes a position B illustrated on the right side in the figure. In the automobile 1 at the position B, the front wheels are steered at a steering angle φ with respect to the vehicle body 8, and as a result, the vehicle body 8 of the automobile 1 is directed at an angle θ with respect to the X-axis.

The travel surface information generation device 22 is configured to generate, by calculation illustrated in the example in FIG. 9, the posture and the acceleration rate of the vehicle body 8 at a position of each minute division 51 along each virtual steering route 82, using the vehicle speed, the acceleration rate, the steering angle, and the like of the automobile 1. The travel surface information generation device 22 is configured to calculate the posture and the acceleration rate of the vehicle body 8 at the position of each minute division 51 along each virtual steering route 82 based on dynamic relation illustrated in the example in FIG. 9.

For example, by assuming that the virtual route allows the vehicle to corner with a radius of turning of a constant curvature without a sideslip in accordance with the steering angle of the steering, the travel surface information generation device 22 is configured to calculate the posture and the acceleration rate of the vehicle body 8 at the position B in FIG. 9 in accordance with the vehicle speed and the steering angle of the automobile 1. Moreover, the travel surface information generation device 22 is configured to calculate, for example, the roll angle, the acceleration rate in the vehicle widthwise direction, and the acceleration rate in the longitudinal direction of the automobile 1 in the minute division 51 overlapping with the position B in FIG. 9.

FIG. 10 is an illustrative diagram of a G-G characteristic of the automobile 1 in FIG. 1. The G-G characteristic indicates relation between an acceleration rate a(y) in the vehicle widthwise direction as a horizontal direction of the automobile 1, and an acceleration rate a(x) in the longitudinal direction of the automobile 1. The horizontal axis in FIG. 10 denotes the acceleration rate a(x) in the longitudinal direction. The vertical axis denotes the acceleration rate a(y) in the vehicle widthwise direction.

Moreover, FIG. 10 illustrates a G-G characteristic curve 71 of the four-wheel drive automobile 1 and a G-G characteristic curve 72 of the front-wheel drive automobile 1. The G-G characteristic curve 71 of the four-wheel drive automobile 1 is larger in area than the G-G characteristic curve 72 of the front-wheel drive automobile 1. That is, the four-wheel drive automobile 1 is less likely to make a sideslip than the front-wheel drive automobile 1, and is configured to travel by tracing a route corresponding to steering. The four-wheel drive automobile 1 has a higher limitation characteristic of traveling by tracing a route, as compared to the front-wheel drive automobile 1.

The travel surface information generation device 22 is configured to determine whether the vehicle body 8 makes a sideslip in each minute division 51 along each virtual steering route 82, using the acceleration rate in the longitudinal direction of the automobile 1, the acceleration rate in the vehicle widthwise direction, and the G-G characteristic curves in FIG. 10.

FIG. 11 is an illustrative diagram of the travelability map data 39 regarding the undeveloped road 10 including the uneven road surface in FIG. 2.

FIG. 12 is an illustrative diagram of the travelability map data 39 regarding the developed paved road 2 in FIG. 1.

Each minute division in the travelability map data 39 in FIGS. 11 and 12 includes information regarding travelability or untravelability. The hatched minute divisions 61 in the figures include the untravelability information. The unhatched minute divisions 62 in the figures include the travelability information.

The travel surface information generation device 22 generates the travelability map data 39 equivalent to that in which the information regarding each minute division 51 is replaced from the unevenness information to the information regarding the determination result of the travelability or the untravelability, based on the determination result of the travelability or the untravelability of each minute division 51 along each virtual steering route 82.

Thus, in the travel surface in FIG. 11, the minute divisions 61 on the left and right sides near the automobile 1 are included in a range where the vehicle travels by virtual routes that allow the vehicle to make large steering under the latest vehicle speed, and there is possibility of an overturn or a sideslip of the automobile 1. Accordingly, the minute divisions 61 on the left and right sides near the automobile 1 include the untravelability information, and are hatched.

Moreover, in the minute divisions 61 overlapping with the stone 13 on the travel surface, there is possibility that the automobile 1 runs aground on the stone 13, resulting in a rollover such as an overturn. Accordingly, the minute divisions 61 overlapping with the stone 13 on the travel surface include the untravelability information, and are hatched.

Furthermore, in the minute divisions 61 overlapping with the standing tree 14 next to the road 10 having the uneven road surface, there is possibility that the automobile 1 interferes with the standing tree 14. Accordingly, the minute divisions 61 overlapping with the standing tree 14 include the untravelability information, and are hatched.

The other minute divisions 62 have no possibility of, for example, a rollover such as an overturn. Accordingly, the other minute divisions 62 include the travelability information, and are unhatched.

Moreover, on the travel surface of the developed paved road 2 in FIG. 12, the minute divisions 61 on the left and right sides near the automobile 1 are included in a range where the vehicle travels by virtual routes that allow the vehicle to make large steering under the latest vehicle speed, and there is possibility of an overturn or a sideslip of the automobile 1. Accordingly, the minute divisions 61 on the left and right sides near the automobile 1 include the untravelability information, and are hatched.

Furthermore, the minute divisions 61 overlapping with the curbstone 6 on the travel surface have possibility that the automobile 1 runs aground on the stone 13, resulting in a rollover such as an overturn. Accordingly, the minute divisions 61 overlapping with the curbstone 6 on the travel surface include the travelability information, and are hatched.

The other minute divisions 62 have no possibility of a rollover such as an overturn. Accordingly, the other minute divisions 62 include the travelability information, and are not hatched.

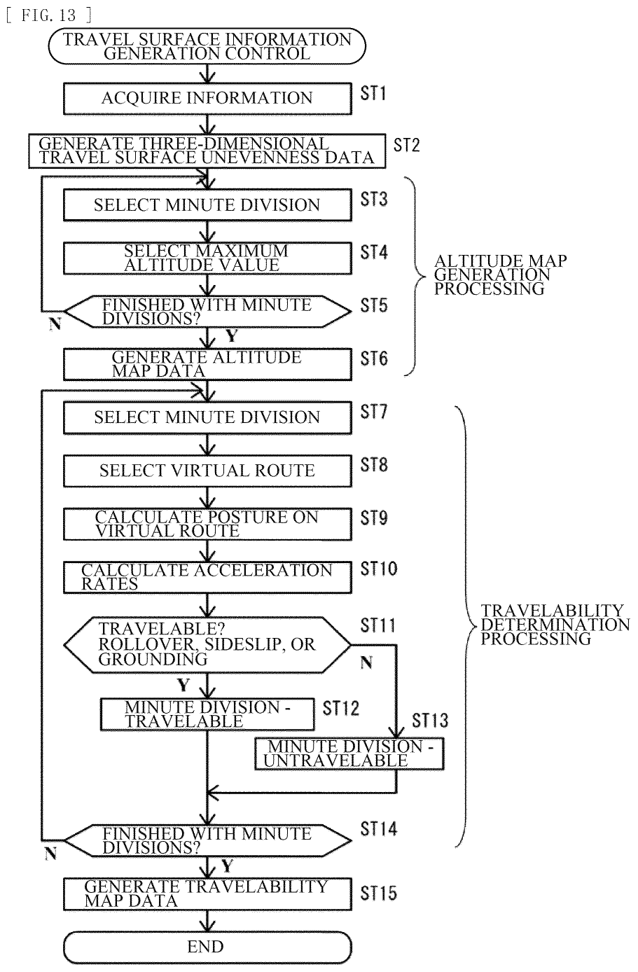

FIG. 13 is a flowchart of a travel surface information generation control by the travel surface information generation device 22 in FIGS. 4 and 5.

The travel surface information generation device 22 repetitively executes the travel surface information generation control in FIG. 13 by the CPU. The travel surface information generation device 22 may repetitively execute the travel surface information generation control in FIG. 13 on equivalent cycles to those of the travel control device 23, in synchronization with very short cycles of the travel control device 23.

In step ST1, the travel surface information generation device 22 acquires, from each unit of the control system 20 in FIG. 2, information regarding the current position and the direction of advance of the automobile 1, the latest travel environment of the vehicle to be used for generation of travel surface information, the latest travel state, the specification information 40 regarding the automobile 1, and the like. It is to be noted that the travel surface information generation device 22 may record, in advance, information to be acquired in a memory and acquire the latest information from the memory. The information to be used for the generation of the travel surface information may include the information described in FIGS. 6 to 10 described above.

In step ST2, the travel surface information generation device 22 generates three-dimensional travel surface unevenness data 37 regarding the travel surface, based on the information acquired in step ST1.

In the three-dimensional travel surface unevenness data 37, for example, the unevenness of the travel surface and the unevenness caused by the obstacle or the like obtained by the processing as the depth coordinate measurer 41, and the unevenness of the travel surface obtained from the high-precision map data 36 are mapped onto respective positions and ranges. In the three-dimensional travel surface unevenness data 37, for example, the unevenness caused by the curbstone 6, the stone 13, the standing tree 14, and the like, the unevenness of the travel surface itself, and the like may be mapped with heights in their respective pieces of information as they are.

Moreover, when information regarding shapes or widths or travelable ranges of the road and the lane in the direction of advance of the automobile 1 is obtainable from road information included in the high-precision map data 36, the travel surface information generation device 22 may map such boundary information onto the three-dimensional travel surface unevenness data 37.

Specifically, for example, when an inclination angle such as the angle of the cant of the road is obtainable from the road information included in the high-precision map data 36, the travel surface information generation device 22 may incline the travel surface in the three-dimensional travel surface unevenness data 37 at the inclination angle.

When the unevenness information regarding the road and the surroundings is acquirable from the road information included in the high-precision map data 36, e.g., information regarding a median strip of the road, a road shoulder of the road, the unevenness of the road and the road shoulder, structures such as walls or fences on a roadside, a level difference caused by the curbstone 6 between the side of the lane and the road shoulder, the vegetation, an entrance to the store 7, and the like, the travel surface information generation device 22 may map these pieces of the unevenness information regarding the travel surface onto the three-dimensional travel surface unevenness data 37.

When a shape of the unevenness or a width or a travelable range of the travel surface in the direction of advance of the automobile 1 is obtainable based on the detection information in the direction of advance by the vehicle external sensor, the LiDAR 32, or the like, the travel surface information generation device 22 may map these pieces of information onto the three-dimensional travel surface unevenness data 37.

When the inclination angle such as the angle of the cant of the travel surface is obtainable based on the detection information in the direction of advance by the vehicle external sensor, the LiDAR 32, or the like, the travel surface information generation device 22 may incline the travel surface in the three-dimensional travel surface unevenness data 37 at the inclination angle.

When the unevenness information regarding the travel surface and the surroundings is obtainable based on the detection information in the direction of advance by the vehicle external sensor or the LiDAR 32, e.g., the information regarding the median strip of the road, the road shoulder of the road, the unevenness of the road and the road shoulder, fallen objects such as fallen rocks, the structures such as the walls and the fences on the roadside, the level difference caused by the curbstone 6, etc. between the lane and the road shoulder, the vegetation, the entrance to the store 7, and the like, the travel surface information generation device 22 may map these pieces of the unevenness information regarding the travel surface onto the three-dimensional travel surface unevenness data 37.

Thus, the travel surface information generation device 22 generates the three-dimensional travel surface unevenness data 37 onto which the unevenness information regarding the travel surface including the direction of advance of the automobile 1 is mapped. The travel surface information generation device 22 records the generated three-dimensional travel surface unevenness data 37 in the memory.

From step ST3 to step ST6, the travel surface information generation device 22 starts altitude map generation processing.

In step ST3, first, the travel surface information generation device 22 associates the minute divisions 51 with the three-dimensional travel surface unevenness data 37 onto which the unevenness information regarding the travel surface is mapped, and selects an unprocessed one of the minute divisions 51 therein.

In step ST4, with respect the minute division 51 selected in step ST3, the travel surface information generation device 22 selects a maximum altitude value of the relevant minute division 51. The travel surface information generation device 22 may select, as the maximum altitude value, the unevenness information regarding a maximum absolute value with respect to the travel surface in the three-dimensional travel surface unevenness data 37 with which the minute division 51 overlaps. The travel surface information generation device 22 selects, as the unevenness information regarding the minute division 51, whichever has the maximum absolute value from among the unevenness information based on the high-precision map data 36 and the unevenness information based on the vehicle external sensor, the LiDAR 32, or the like.

The maximum altitude value selected in this way is, for example, the height of the curbstone 6 or the stone 13 protruding upward from the travel surface, a height of a bump of the travel surface, or a depth of a recess in the travel surface.

In step ST5, the travel surface information generation device 22 determines whether the selection has been finished with respect to all the minute divisions 51 associated with the three-dimensional travel surface unevenness data 37. When the selection has not been finished with respect to all the minute divisions 51, that is, if any minute divisions 51 are left unprocessed, the travel surface information generation device 22 causes the processing to return to step ST3. The travel surface information generation device 22 repeats the processing from step ST3 to step ST5 until the selection has been finished with respect to all the minute divisions 51. When the selection has been finished with respect to all the minute divisions 51, the travel surface information generation device 22 causes the processing to proceed to step ST6.

In step ST6, the travel surface information generation device 22 generates the altitude map data 38 including the maximum altitude value for each minute division 51 selected in step ST4 as the unevenness information for each minute division 51.

As described, the travel surface information generation device 22 generates the three-dimensional unevenness information regarding the travel surface in association with each minute division 51, to generate the altitude map data 38 including the unevenness information for each minute division 51 regarding the travel surface in the direction of advance. The travel surface information generation device 22 records the generated altitude map data 38 in the memory.

From step ST7 to step ST14, the travel surface information generation device 22 starts determination processing of the travelability or the untravelability with respect to the minute divisions 51.

In step ST7, first, the travel surface information generation device 22 selects one unprocessed minute division 51 from among the minute divisions 51 included in the altitude map data 38.

In step ST8, the travel surface information generation device 22 selects a virtual route to virtually travel through the minute division 51 selected in step ST7, from among the virtual routes 49.

The travel surface information generation device 22 generates the virtual routes 49 in FIG. 8 with respect to the travel surface in the predetermined range.

In this case, the travel surface information generation device 22 may select the virtual route overlapping with the minute division 51 selected in step ST7 from among the virtual routes 49 in FIG. 8.

In addition, for example, when assuming that the vehicle travels to allow the minute division 51 selected in step ST7 overlaps with the wheel 9 as illustrated in FIG. 7, the travel surface information generation device 22 may select the virtual route overlapping with the minute division 51 that overlaps with a centroid position 92 of the automobile 1.

It is to be noted that there is possibility that virtual routes overlap with one minute division 51. In this case, the travel surface information generation device 22 may select, for example, whichever has the largest curvature, from among the virtual routes overlapping with the minute division 51.

In step ST9, the travel surface information generation device 22 calculates the posture of the automobile 1 when traveling through the minute division 51 selected in step ST7 by the virtual route.

The travel surface information generation device 22 calculates the posture of the automobile 1 traveling through the minute division 51, with respect to the automobile 1 traveling along the virtual route. At this occasion, the travel surface information generation device 22 may acquire the travel state of the automobile 1 such as the latest position, the speed, the acceleration rate, and steering angle of the automobile 1 as travel reference information, and calculate the posture of the automobile 1 when traveling along the virtual route by traveling after the travel reference information.

Here, for example, as illustrated in FIG. 7, the travel surface information generation device 22 may calculate the posture of the automobile 1 with respect to a state where one of the four wheels 9 of the automobile 1 is placed on the minute division 51. In this case, the other wheels 9 are placed on other minute divisions 51. The travel surface information generation device 22 may select the four minute divisions 51 on which the four wheels 9 of the automobile 1 are placed, based on the fact that the automobile 1 is traveling along the virtual route, and calculate an inclination angle in each of the pitch, roll, and yaw directions of the automobile 1, as the posture of the automobile 1, based on differences in altitude information regarding the four minute divisions 51.

This makes it possible for the travel surface information generation device 22 to calculate the posture of the automobile 1 using one or both of the specification information 40 regarding the automobile 1 and the information regarding the travel state of the automobile 1 with respect to the unevenness information regarding the travel surface for each minute division 51 included in the altitude map data 38.

Moreover, it is possible for the travel surface information generation device 22 to calculate roll, pitch and yaw postures, etc. of the automobile 1 in each minute division 51 when traveling along each virtual route.

In step ST10, the travel surface information generation device 22 further calculates the acceleration rate of the automobile 1 in the vehicle widthwise direction and the acceleration rate of the automobile 1 in the longitudinal direction.

The travel surface information generation device 22 may calculate the acceleration rate of the automobile 1 in the vehicle widthwise direction and the acceleration rate of the automobile 1 in the longitudinal direction based on the fact that the automobile 1 is traveling along the virtual route under the condition on which the posture is calculated in step ST9.

The travel surface information generation device 22 may calculate the acceleration rate of the automobile 1 in the vehicle widthwise direction and the acceleration rate of the automobile 1 in the longitudinal direction, assuming that, for example, the vehicle is traveling at the position B in the travel surface in FIG. 9.

In step ST11, the travel surface information generation device 22 determines, for each minute division 51, the travelability or the untravelability of the minute division 51 for the automobile 1, using the posture and the acceleration rates of the automobile 1 calculated in steps ST9 to ST10.

Here, the travel surface information generation device 22 may determine the travelability or the untravelability of the minute division 51 for the automobile 1, based on possibility of a rollover such as an overturn of the automobile 1, a sideslip of the automobile 1, and grounding of the vehicle body 8 against the road surface, or the like.

For example, when the roll angle as the posture of the automobile 1 exceeds the roll limit angle included in the specification information 40 regarding the automobile 1, the travel surface information generation device 22 determines that there is possibility of a rollover by an overturn of the automobile 1. In contrast, when the roll angle is equal to or smaller than the roll limit angle, the travel surface information generation device 22 determines that there is no possibility of a rollover by an overturn of the automobile 1. Here, as the roll limit angle, that which is obtained by adding a predetermined margin to the roll limit angle in the specification information 40 regarding the automobile 1 may be used.

Moreover, using the acceleration rate of the automobile 1 in the longitudinal direction, the travel surface information generation device 22 acquires a limit acceleration rate of the automobile 1 in the vehicle widthwise direction based on the G-G characteristic in FIG. 10 as the specification information 40 regarding the automobile 1. In FIG. 10, the limit acceleration rate in the vehicle widthwise direction corresponding to the acceleration rate ax in the longitudinal direction is denoted as aymax. The travel surface information generation device 22 compares the acceleration rate of the automobile 1 in the vehicle widthwise direction with the limit acceleration rate. When the acceleration rate of the automobile 1 in the vehicle widthwise direction exceeds the limit acceleration rate, the travel surface information generation device 22 determines that the automobile 1 makes a sideslip. In contrast, when the acceleration rate of the automobile 1 in the vehicle widthwise direction is equal to or smaller than the limit acceleration rate, the travel surface information generation device 22 determines that the automobile 1 is able to travel by tracing the virtual route without a sideslip. Here, as the limit acceleration rate to be compared with the acceleration rate of the automobile 1 in the vehicle widthwise direction, that which is obtained by adding a predetermined margin to the limit acceleration rate aymax obtained from FIG. 10 may be used.

Furthermore, the travel surface information generation device 22 determines whether unevenness underneath the vehicle body 8 of the automobile 1 comes into contact with the vehicle body 8 of the automobile 1, using information regarding the posture of the automobile 1 and the unevenness information regarding the minute divisions 51 underneath the automobile 1. Thus, when the unevenness underneath the vehicle body 8 of the automobile 1 comes into contact with the vehicle body 8 of the automobile 1, the travel surface information generation device 22 determines that the vehicle grounds. In contrast, when the unevenness underneath the vehicle body 8 of the automobile 1 does not come into contact with the vehicle body 8 of the automobile 1, the travel surface information generation device 22 determines that the vehicle does not ground.

In addition, when determining that there is possibility of any one of a rollover, a sideslip, and the grounding, the travel surface information generation device 22 determines that the minute division 51 selected in step ST7 is untravelable. In this case, the travel surface information generation device 22 causes the processing to proceed to step ST13.

In contrast, when it is not determined that there is possibility of all of a rollover, a sideslip, and the grounding, the travel surface information generation device 22 determines that the minute division 51 selected in step ST7 is travelable. In this case, the travel surface information generation device 22 causes the processing to proceed to step ST12.

Thus, it is possible for the travel surface information generation device 22 to determine that the automobile 1 does not roll over in each minute division 51 in a first case where the roll, pitch, and yaw postures, etc. of the automobile 1 in each minute division 51 when traveling along the virtual straight route 81 and each of the virtual steering routes 82 by traveling after the travel reference information is equal to or smaller than a rollover limit of the automobile 1, and in a second case where the acceleration rate of the automobile 1 in a lateral direction in each minute division 51 when traveling along each virtual route by traveling after the travel reference information is equal to or smaller than a cornering limit acceleration rate at which no sideslip of the automobile 1 occurs. Moreover, when either of the first case and the second case is unestablished, it is possible for the travel surface information generation device 22 to determine that the automobile 1 rolls over in each minute division 51.

In step ST12, the travel surface information generation device 22 sets the travelability information with respect to the minute division 51 selected in step ST7. Thereafter, the travel surface information generation device 22 causes the processing to proceed to step ST14.

In step ST13, the travel surface information generation device 22 sets the untravelablity information with respect to the minute division 51 selected in step ST7. Thereafter, the travel surface information generation device 22 causes the processing to proceed to step ST14.

In step ST14, the travel surface information generation device 22 determines whether the selection has been finished with respect to all the minute divisions 51 in the altitude map data 38. When the selection has not been finished with respect to all the minute divisions 51, that is, if any minute divisions 51 are left unprocessed, the travel surface information generation device 22 causes the processing to return to step ST7. The travel surface information generation device 22 repeats the processes from step ST7 to step ST14 until the selection has been finished with respect to all the minute divisions 51. When the selection has been finished with respect to all the minute divisions 51, the travel surface information generation device 22 causes the processing to proceed to step ST15.

In step ST15, the travel surface information generation device 22 generates the travelability map data 39 in which the unevenness information for each minute division 51 in the altitude map data 38 is replaced with the determination result of the travelability or the untravelability for each minute division 51, based on the determination result of the determination processing.

Thus, it is possible for the travel surface information generation device 22 to generate the travelability map data 39 by the travelability map generation processing. The travelability map data 39 includes the minute divisions 51 similar to the altitude map data 38. Each minute division 51 has the untravelability information when the automobile 1 rolls over, grounds, or makes a sideslip. In contrast, the minute division 51 in which the automobile 1 neither rolls over, grounds, nor makes a sideslip has the travelability information. The travel surface information generation device 22 records the generated travelability map data 39 in the memory, and outputs the travelability map data 39 to the travel control device 23.

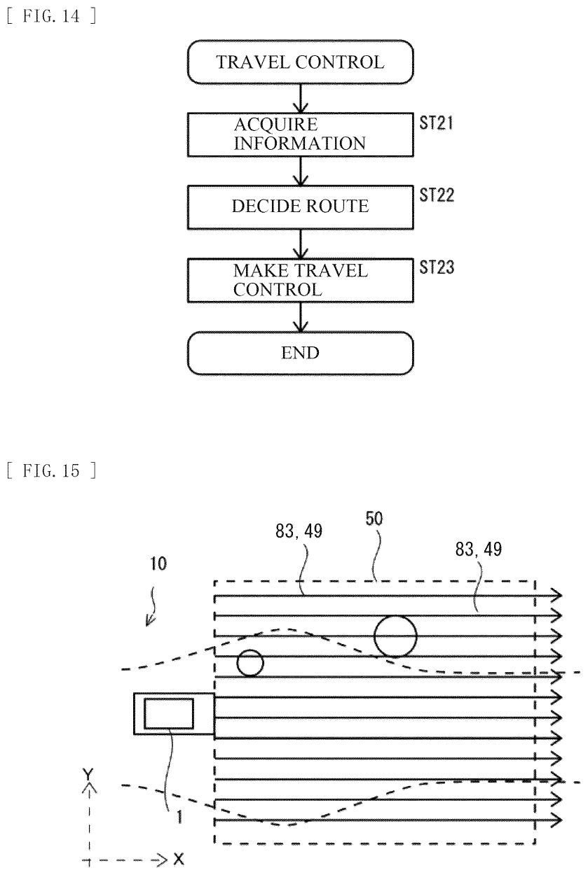

FIG. 14 is a flowchart of a travel control of the automobile 1 by the travel control device 23 in FIG. 4.

The travel control device 23 repetitively executes the travel control in FIG. 14. The travel control device 23 may repetitively execute the travel control in FIG. 14 basically on very short cycles.

In step ST21, the travel control device 23 acquires the information from each unit of the control system 20 of the automobile 1. The travel control device 23 of the embodiment acquires the travelability map data 39 from the travel surface information generation device 22 in addition to the detection information by the vehicle external camera 31 or the like and the information such as the high-precision map data 36.

In step ST22, the travel control device 23 decides the route to be used for the current travel control.

The travel control device 23 basically decides the route based on the latest detection information by the vehicle external camera 31 or the like, to cope with the latest state of the subject vehicle or the situation outside the vehicle.

In the embodiment, furthermore, the travel control device 23 decides the route using the travelability map data 39. At this occasion, the travel control device 23 decides the route to travel on the travel surface in the direction of advance, to allow the vehicle to travel while giving priority to whichever minute division 51 is considered to be travelable in the travelability map data 39 over whichever minute division 51 is considered to be untravelable in the travelability map data 39.

For example, as illustrated in FIG. 11 or 12, the travel control device 23 decides a route 65 that fits inside the predetermined range 60.

In step ST23, the travel control device 23 controls the travel of the automobile 1 to allow the automobile 1 to travel by the route decided in step ST22.

For the autonomous automated driving, the travel control device 23 generates the control values corresponding to the route decided in step ST22, and outputs the control values to the driving control device 24, the steering control device 25, and the braking control device 26.

This makes it possible for the automobile 1 to travel by the autonomous automated driving under the control of the travel control device 23.

For example, as to the developed paved road 2 in FIG. 1, the travelability map data 39 in FIG. 12 is generated by the travel surface information generation device 22. On the travel surface in the predetermined range 60 in the travelability map data 39 in FIG. 12, the minute divisions 61 on both left and right sides near the automobile 1 and the minute division 61 overlapping with the curbstone 6 are considered to be untravelable.

In this case, for example, as illustrated in FIG. 12, the travel control device 23 decides one by one, on each control cycle, the routes 65 to head for the second parking space P2.

As a result, as illustrated in FIG. 12, it is possible for the automobile 1 to travel on the lane 3 of the developed paved road 2, and thereafter, travel toward the second parking space P2 of the store 7 next to the paved road 2. It is possible for the automobile 1 to travel toward the second parking space P2, not to run aground on the high curbstone 6.

Moreover, as to the undeveloped road 10 including the uneven surface in FIG. 2, the travelability map data 39 in FIG. 11 is generated by the travel surface information generation device 22. On the travel surface in the predetermined range 60 in the travelability map data 39 in FIG. 11, the minute divisions 61 on both left and right sides near the automobile 1, the minute divisions 51 overlapping with the stone 13, and the minute divisions 61 overlapping with the standing tree 14 are considered to be untravelable.

In this case, for example, as illustrated in FIG. 11, the travel control device 23 decides one by one, on each control cycle, the routes 65 to head for the flat space 15 available for parking without the standing tree 14 or the like, in the roadside space 12.

As a result, as illustrated in FIG. 11, it is possible for the automobile 1 to travel on the undeveloped road 10 including the uneven surface, and thereafter, travel toward the space 15 available for parking beside the road 10 including the uneven surface. It is possible for the automobile 1 to travel toward the space 15 available for parking and stop safely in the space 15 available for parking, not to interfere with the stone 13 on the travel surface or the standing tree 14. When an emergency or the like occurs in the automobile 1, it is possible for the automobile 1 traveling by the autonomous automated driving to move toward the road shoulder of the road and be stopped on the road shoulder.

As described above, in the embodiment, the travel surface information generation device 22 of the automobile 1 is provided, together with the travel control device 23. The travel surface information generation device 22 generates the information regarding the travel surface such as the road surface and the road shoulder in the direction of advance of the automobile 1. The travel control device 23 is configured to control the travel of the automobile 1. This saves the travel control device 23 from performing the processing of generating the information regarding the travel surface. It is possible for the travel control device 23 to decide the route of the automobile 1 based on the latest information at each time point, on very short cycles, to cope with the travel environment of the automobile 1 that changes every moment in accordance with the travel, etc., and allow the automobile 1 to travel by the decided route.

Moreover, the travel surface information generation device 22 of the embodiment acquires one or both of the information by the vehicle external sensor and the information regarding the high-precision map data 36 acquirable for the automobile 1, and generates the altitude map data 38 based on the acquired information. In the altitude map generation processing, the travel surface information generation device 22 generates, for each minute division 51, the unevenness information regarding the travel surface in the direction of advance, and generates the altitude map data 38 including the unevenness information for each minute division 51 regarding the travel surface in the direction of advance, from the generated unevenness information regarding the travel surface.

Furthermore, the travel surface information generation device 22 determines, for each minute division 51, the travelability or the untravelability of the travel surface for the automobile 1, using one or both of the specification information 40 regarding the automobile 1 and the information regarding the travel state, with respect to the unevenness information regarding the travel surface for each minute division 51 included in the altitude map data 38 generated by the altitude map generation processing. Moreover, the travel surface information generation device 22 generates the travelability map data 39 in which the unevenness information for each minute division 51 in the altitude map data 38 is replaced with the determination result of the travelability or the untravelability for each minute division 51, based on the determination result of the determination processing.

Thus, it is possible for the travel control device 23 to acquire the travelability map data 39 including the result in which the travelability or the untravelability is determined in advance with respect to the current travel or the like of the automobile 1, and decide the route to travel on the travel surface in the direction of advance. It is possible for the travel control device 23 to select the route to allow the vehicle to travel while giving priority to whichever minute division 62 is considered to be travelable in the travelability map data 39 over whichever minute division 61 is considered to be untravelable in the travelability map data 39, to decide the route 65 to travel by a travelable route, by easy and time-saving processing.

Moreover, to generate the travelability map data 39, the travel surface information generation device 22 first divides the travel surface of the automobile 1 including the road surface to be actually traveled by the automobile 1, i.e., the travel surface of the automobile 1, into the minute divisions 51, and generates the altitude map data 38 including the unevenness information for each minute division 51. It is possible for the travel surface information generation device 22 to generate the altitude map data 38 including the unevenness information covering the travel surface, in a short time by finite processes in which the travel surface is quantized for each minute division 51.

Furthermore, the travel surface information generation device 22 determines the travelability or the untravelability for the automobile 1 for each minute division 51 in the altitude map data 38. Thus, the travel surface information generation device 22 replaces the unevenness information regarding each minute division 51 in the altitude map data 38 with the determination result of the travelability or the untravelability for each minute division 51, to generate the travelability map data 39. It is possible for the travel surface information generation device 22 to generate the travelability map data 39 in a short time as well.

Thus, it is possible for the travel surface information generation device 22 to generate the travelability map data 39 and continuously update the travelability map data 39 by the series of processes to be finished in a short time. It is possible for the travel surface information generation device 22 to continuously update the travelability map data 39 to correspond to the control cycles of the travel control device 23.

In contrast, for example, if the altitude map data 38 is not quantized for each minute division 51, the travel surface information generation device 22 and the travel control device 23 determine the travelability or the untravelability with respect to a selected route. Moreover, when the selected route is untravelable, the travel surface information generation device 22 and the travel control device 23 select a new route and repeat the processing. In such loop processing, it is unclear how long it takes to decide a final route available for the travel control. When assuming that it is necessary to perform the travel control on short cycles, there is possibility that the series of the controls are not established but end in failure.

In the embodiment, in the determination processing, the travel surface information generation device 22 generates the virtual routes 49 to travel on the travel surface included in the altitude map data 38. Moreover, the travel surface information generation device 22 calculates the roll, pitch, and yaw postures, etc. of the automobile 1 in each minute division 51 when traveling by each virtual route. Thus, the travel surface information generation device 22 determines whether the roll, pitch, and yaw postures, etc. of the automobile 1 causes the vehicle to roll over, ground, or make a sideslip, when traveling in each minute division 51.

Thus, it is possible for the travel surface information generation device 22 to generate the travelability map data 39 in which the minute division 51 where the automobile 1 does not roll over while traveling is considered to be the travelable minute division 62. Accordingly, it is possible for the travel control device 23 to decide the route to allow the vehicle to travel while giving priority to whichever minute division 62 is considered to be travelable in the travelability map data 39 over whichever minute division 61 is considered to be untravelable, and to decide the route where the vehicle does not roll over because of, for example, the unevenness of the road surface. The automobile 1 is expected to travel without a rollover, etc. because of the unevenness, etc. of the road surface, under the control of the travel control device 23.

Moreover, in the embodiment, the travel surface information generation device 22 determines the travelability or the untravelability with respect to the virtual routes 49. In this case, basically, the virtual routes 49 may be the combinations that allow the vehicle to comprehensively travel through all the minute divisions 51 included in the altitude map data 38. It suffices that the travel surface information generation device 22 determines the travelability or the untravelability with respect to the finite number of the virtual routes 49 corresponding to the minute divisions 51.

In contrast, for example, assume that the travel surface information generation device 22 and the travel control device 23 determine the travelability or the untravelability with respect to a route selected one by one. Moreover, when the selected route is untravelable, the travel surface information generation device 22 and the travel control device 23 select a new route and repeat the processing. In such loop processing, it is unclear how long it takes to decide a final travelable route available for the travel control. When assuming that it is necessary to perform the travel control on short cycles, there is possibility that the series of the controls are not established but end in failure.

As a result, in the embodiment, it is possible for the travel surface information generation device 22 to determine in advance the travelability or the untravelability with respect to the unevenness of the travel surface to be traveled by the automobile 1, and it is possible for the travel control device 23 of the automobile 1 to decide the route in accordance with the determination result of the travelability or the untravelability. The automobile 1 of the embodiment makes it possible to decide the route and travel, to cope with, for example, the undeveloped road 10 including the uneven surface, the unevenness caused by the curbstone 6 on the road 2 on which the vehicle is traveling, and to make a stop on a safe road shoulder without unevenness.

In the embodiment, it is possible to make improvement to allow the subject vehicle as the traveling vehicle to decide the route of the vehicle while ensuring a stable posture.

### Second Embodiment

Next, an automobile 1 according to a second embodiment of the invention is described.

In the embodiment, the travel surface information generation device 22 of the automobile 1 generates the altitude map data 38 based on only the information by the various vehicle external sensors provided in the subject vehicle without using the high-precision map data 36.

In the following, differences from the forgoing embodiments are mainly described.

In this case, in step ST2 in FIG. 13, the travel surface information generation device 22 maps the unevenness of the travel surface and the unevenness caused by the obstacle or the like obtained by the processing as the depth coordinate measurer 41, onto the respective positions and ranges. In the three-dimensional travel surface unevenness data 37, for example, the unevenness caused by the curbstone 6, the stone 13, the standing tree 14, and the like, the unevenness of the travel surface itself, and the like may be mapped with the heights in their respective pieces of information as they are.

When the shape of the unevenness or the width or the travelable range of the travel surface in the direction of advance of the automobile 1 is obtainable based on the detection information in the direction of advance by the vehicle external sensor, the LiDAR 32, or the like, the travel surface information generation device 22 maps these pieces of information onto the three-dimensional travel surface unevenness data 37.

When the inclination angle such as the angle of the cant of the travel surface is obtainable based on the detection information in the direction of advance by the vehicle external sensor, the LiDAR 32, or the like, the travel surface information generation device 22 inclines the travel surface in the three-dimensional travel surface unevenness data 37 at the inclination angle.

When the unevenness information regarding the travel surface and the surroundings is acquirable based on the detection information in the direction of advance by the vehicle external sensor and the LiDAR 32, e.g., the information regarding the median strip of the road, the road shoulder of the road, the unevenness of the road and the road shoulder, fallen objects such as fallen rocks, the structures such as the walls and the fences on the roadside, the level differences caused by the curbstone 6, etc. between the lane and the road shoulder, the vegetation, the entrance to the store 7, and the like, the travel surface information generation device 22 maps these pieces of the unevenness information regarding the travel surface onto the three-dimensional travel surface unevenness data 37.

Hence, it is possible for the travel surface information generation device 22 to generate the altitude map data 38 in step ST6 based on only the information by the various vehicle external sensors provided in the subject vehicle without using the high-precision map data 36.

As described above, in the embodiment as well, it is possible for the travel surface information generation device 22 of the automobile 1 to determine in advance the travelability or the untravelability with respect to the unevenness of the travel surface to be traveled by the automobile 1, and it is possible for the travel control device 23 to decide the route in accordance with the determination result of the travelability or the untravelability. The automobile 1 of the embodiment makes it possible to decide the route and travel, to cope with, for example, the undeveloped road 10 including the uneven surface, the unevenness caused by the curbstone 6 on the road 2 on which the vehicle is traveling, and to make a stop on a safe road shoulder without unevenness.

### Third Embodiment

Next, an automobile 1 according to a third embodiment of the invention is described.

The embodiment differs from the forgoing embodiment in the determination of the travelability or the untravelability for each minute division 51 by the travel surface information generation device 22 of the automobile 1, to generate the travelability map data 39 from the altitude map data 38.

In the following, differences from the forgoing embodiments are mainly described.

FIG. 15 is an illustrative diagram of the virtual routes 49 in the third embodiment of the invention.

In FIG. 15, the undeveloped road 10 including the uneven road surface in the road in FIG. 2 is illustrated in the superimposed manner.

In the embodiment, in step ST8 in FIG. 13, the travel surface information generation device 22 selects whichever overlaps with the minute division 51 selected in step ST7, from virtual straight-line routes 83 illustrated in FIG. 15.

Here, the virtual straight-line routes 83 are combinations that overlap with all the minute divisions 51 with respect to the travel surface indicated by the altitude map data 38.

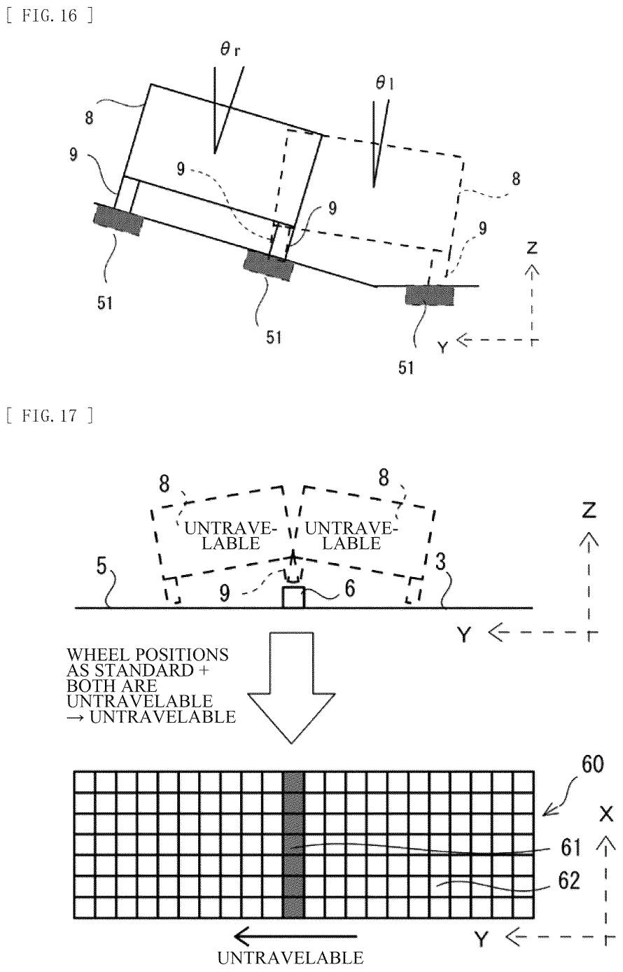

FIG. 16 is an illustrative diagram of an example of a rollover determination in the minute division 51 by the virtual routes in FIG. 15.

In step ST9 in FIG. 13, the travel surface information generation device 22 may calculate the posture in the state in the example in FIG. 16.

In FIG. 16, the travel surface is inclined with respect to a horizontal plane (XY plane).

In this case, in step ST9 in the determination processing, the travel surface information generation device 22 calculates the posture with the wheel 9 on right side of the automobile 1 placed on the minute division 51 as indicated by a solid line in FIG. 16, and the posture with the wheel 9 on left side of the automobile 1 placed on the minute division 51 as indicated by a broken line in FIG. 16.

Here, first, the travel surface information generation device 22 selects the virtual straight-line route 83 that passes through the selected minute division 51, from the virtual routes 49.

Next, the travel surface information generation device 22 calculates the posture of the automobile 1 traveling along the selected virtual straight-line route 83, in a state where the automobile 1 is traveling on the minute division 51. At this occasion, the travel surface information generation device 22 may acquire the travel state of the automobile 1 such as the latest position, the speed, the acceleration rate, and the steering angle of the automobile 1, as the travel reference information, and calculate the posture of the automobile 1 when traveling along the virtual straight-line route 83 by traveling after the travel reference information.

Moreover, the travel surface information generation device 22 may calculate the posture of the automobile 1 with respect to the state where one of the four wheels 9 on the right side of the automobile 1 is placed on the minute division 51, as indicated by, for example, the solid line in FIG. 16. In this case, the other wheels 9 are placed on other minute divisions 51. The travel surface information generation device 22 may select the four minute divisions 51 on which the four wheels 9 of the automobile 1 are placed, based on the fact that the automobile 1 is traveling along the virtual straight-line route 83, and calculate the inclination angle in each of the pitch, roll, and yaw directions of the automobile 1 as the posture of the automobile 1 based on differences in the altitude information regarding the four minute divisions 51. In FIG. 16, the automobile 1 is inclined to the right at a roll angle Or.

Furthermore, the travel surface information generation device 22 may calculate the posture of the automobile 1 with respect to the state where one of the four wheels 9 on the left side of the automobile 1 is placed on the minute division 51, as indicated by, for example, the broken line in FIG. 16. In this case, the other wheels 9 are placed on other minute divisions 51. The travel surface information generation device 22 may select the four minute divisions 51 on which the four wheels 9 of the automobile 1 are placed, based on the fact that the automobile 1 is traveling along the virtual straight-line route 83, and calculate the inclination angle in each of the pitch, roll, and yaw directions of the automobile 1 as the posture of the automobile 1, based on the differences in the altitude information regarding the four minute divisions 51. In FIG. 16, the automobile 1 is inclined to the right with a roll angle 01.

This makes it possible for the travel surface information generation device 22 to calculate the posture of the automobile 1 using one or both of the specification information 40 regarding the automobile 1 and the information regarding the travel state, with respect to the unevenness information regarding the travel surface for each minute division 51 included in the altitude map data 38.

Moreover, it is possible for the travel surface information generation device 22 to calculate the roll, pitch, and yaw postures, etc. of the automobile 1 in each minute division 51 when traveling along each virtual straight-line route 83.

Thus, in step ST11, the travel surface information generation device 22 determines the possibility of the rollover by the overturn of the automobile 1, with respect to the posture in a first case in which the wheel 9 on the right side of the automobile 1 denoted by the solid line in FIG. 16 passes through the minute division 51, and the posture in a second case in which the wheel 9 on the left side of the automobile 1 denoted by the broken line in FIG. 16 passes through the minute division 51. The travel surface information generation device 22 determines the possibility of the rollover by the overturn of the automobile 1 based on whether the roll angle of each posture exceeds the roll limit angle as the rollover limit of the roll angle included in the specification information 40 regarding the automobile 1. For example, the travel surface information generation device 22 determines whether the two roll angles Or and 01 in FIG. 16 exceed the roll limit angle.

Moreover, when it is determined that the automobile 1 is not equal to or smaller than the rollover limit of the roll angle, with respect to both the posture in the first case and the posture in the second case, the travel surface information generation device 22 determines that the automobile 1 rolls over in the minute division 51. In this case, the travel surface information generation device 22 determines that the minute division 51 selected in step ST7 is untravelable. In this case, the travel surface information generation device 22 causes the processing to proceed to step ST13.

In contrast, when it is not determined that the automobile 1 is not equal to or smaller than the rollover limit of the roll angle in one or both of the first case and the second case, the travel surface information generation device 22 determines that the automobile 1 does not roll over in each minute division 51. In this case, the travel surface information generation device 22 causes the processing to proceed to step ST12.

FIG. 17 is an illustrative diagram of travelability map data 60 to be generated based on a determination of the untravelability only when untravelable on both the right side and the left side, with the wheel positions as a standard, as in the embodiment. In this case, a determination of the travelability is made, when untravelable on either the right side or the left side, and when travelable on both the right side and the left side.

In the case in FIG. 17, as illustrated in an upper part in FIG. 17, the automobile 1 is traveling on a road on which the curbstone 6 is provided to protrude between the lane 3 and the sidewalk 5 of the paved road.

In this case, when untravelable on both the right side and the left side, the minute division is considered to be the untravelable minute division 61. Accordingly, in the travelability map data 60 illustrated in a lower part in FIG. 17, the minute divisions including the curbstone 6 are considered to be the untravelable minute divisions 61 by the travel surface information generation device 22. Moreover, all the minute divisions that do not include the curbstone 6 are considered to be the travelable minute divisions 61.

Thus, the automobile 1 traveling on the lane 3 is not able to travel beyond the untravelable minute division. As a result, the travel control device 23 of the automobile 1 is inhibited from controlling the travel of the automobile 1 to run across the curbstone 6.

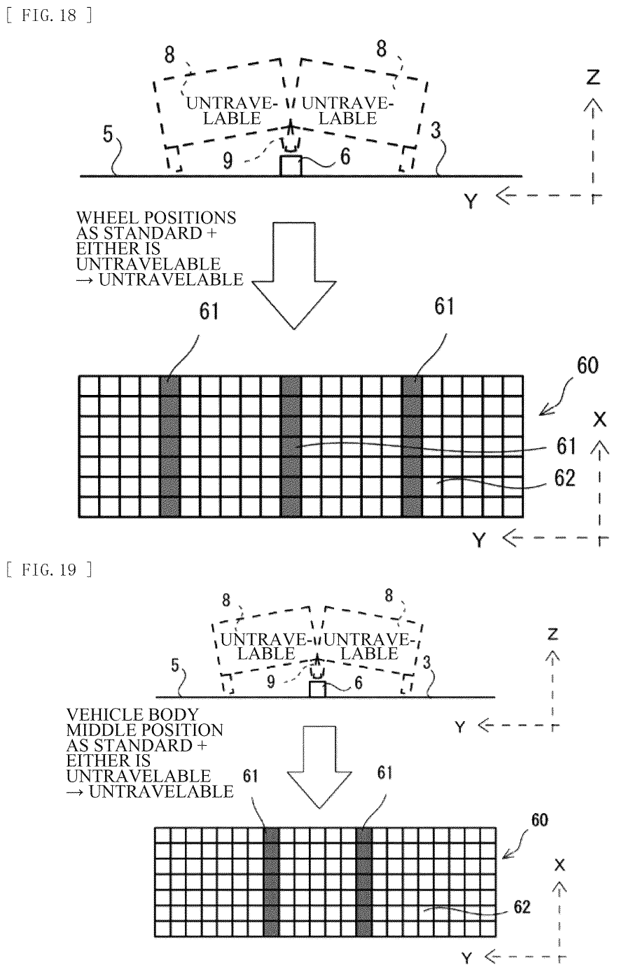

FIG. 18 is an illustrative diagram of travelability map data regarding a comparative example to be generated based on a determination of the untravelability when untravelable on either the right side or the left side, with the wheel positions as the standard, unlike the embodiment. In this case, the determination of travelablity is made when travelable on both the right side and the left side.

In the case in FIG. 18, as with FIG. 17, the automobile 1 is traveling on the road on which the curbstone 6 is provided to protrude between the lane 3 and the sidewalk 5 of the paved road.

In this case, the determination of the untravelability is made when untravelable on either the right side or the left side. Accordingly, in the travelability map data 60 illustrated in a lower part in FIG. 18, unlike FIG. 17, the travel surface information generation device 22 considers not only the minute divisions including the curbstone 6 but also the minute divisions away from the curbstone 6 by the horizontal width of the vehicle body 8 to be the untravelable minute divisions 61. It is to be noted that all the other minute divisions are considered to be the travelable minute divisions 61.

Thus, making the determination of the untravelability when untravelable on either the right side or the left side causes not only the untravelable minute divisions but also the originally travelable minute divisions to be considered to be the untravelable minute divisions.

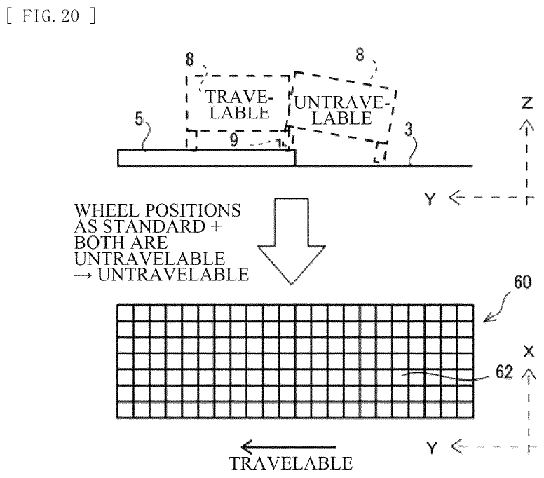

FIG. 19 is an illustrative diagram of travelability map data regarding another comparative example to be generated based on the determination of the untravelability when untravelable on either the right side or the left side, with the horizontal middle of the vehicle body as the standard, unlike the embodiment. In this case, the determination of the travelability is made when travelable on both the right side and the left side.

In the case in FIG. 19, as with FIG. 17, the automobile 1 is traveling on the road on which the curbstone 6 is provided to protrude between the lane 3 and the sidewalk 5 of the paved road.

In this case, the horizontal middle of the vehicle body serves as the standard. Accordingly, unlike not only FIG. 17 but also FIG. 18, the travel surface information generation device 22 considers the minute divisions away from the minute divisions including the curbstone 6 by a half a horizontal length of the vehicle body 8, to be the untravelable minute divisions 61.

Moreover, all the other minute divisions including the minute divisions including the curbstone 6 are considered to be the travelable minute division 61. The untravelable minute divisions including the curbstone 6 are not considered to be the untravelable minute division 61. The travelable minute divisions that do not include the curbstone 6 are considered to be the untravelable minute divisions 61.

FIG. 20 is an illustrative diagram of travelability map data to be generated based on the determination of the untravelability only when untravelable on both the right side and the left side, with the wheel positions as the standard as in the embodiment. In this case, the determination of the travelability is made when untravelable on either the right side or the left side, and when travelable on both the right side and the left side.

In the case in FIG. 20, as illustrated in an upper part in FIG. 20, the automobile 1 is traveling on a road including the lane 3 of a paved road and the sidewalk 5 higher than the lane 3.

In this case, unlike FIG. 17, the travel surface information generation device 22 considers all the minute divisions including a level difference between the lane 3 and the sidewalk 5 to be the travelable minute divisions 61, as with the other minute divisions.

As a result, it is possible for the travel control device 23 of the automobile 1 to control the travel of the automobile 1, to allow the automobile 1 traveling on the lane 3 to run across the level difference between the lane 3 and the sidewalk 5.

It is possible for the travel control device 23 to control the travel of the automobile 1 to travel while running across the level difference between the lane 3 and the sidewalk 5, for example, from the lane 3 in FIG. 1 toward the second parking space P2.

As described above, in the embodiment as well, it is possible for the travel surface information generation device 22 of the automobile 1 to determine in advance the travelability or the untravelability with respect to the unevenness of the travel surface on which the automobile 1 travels, and it is possible for the travel control device 23 to decide the route in accordance with the determination result of the travelability or the untravelability. The automobile 1 of the invention makes it possible to decide the route and travel, to cope with, for example, the undeveloped road 10 including the uneven surface, and the unevenness caused by the curbstone 6 on the road 2 on which the vehicle is traveling, and to make a stop on a safe road shoulder without unevenness.

The forgoing embodiments are examples of preferred embodiments of the invention, but the invention is by no means limited thereto. Various modifications and alterations are possible.

In the forgoing embodiments, the travel surface information generation device 22 and the travel control device 23 are provided as separate control devices in the control system 20 in FIG. 4, and are separately coupled to the vehicle network 29.

Alternatively, for example, the travel surface information generation device 22 and the travel control device 23 may be provided in the control system 20 as one control device.

### DESCRIPTION OF REFERENCE NUMERALS

1 Automobile (vehicle)
2 Paved road
3 Lane
4 Opposite lane
5 Sidewalk
6 Curbstone
7 Store
8 Vehicle body
9 Wheel
10 Undeveloped road
12 Roadside space
13 Stone
14 Standing tree
15 Space available for parking
20 Control system
21 Sensor control device
22 Travel surface information generation device
23 Travel control device
24 Driving control device
25 Steering control device
26 Braking control device
29 Vehicle network
30 GNSS receiver
31 Vehicle external camera
32 LiDAR
33 IMU sensor
34 Odometry sensor
35 Vehicle speed sensor
36 High-precision map data
37 Three-dimensional travel surface unevenness data
38 Altitude map data
39 Travelability map data
40 Specification information
41 Depth coordinate measurer
42 Steering angle acquirer
43 Horizontal angle estimator
44 Kind acquirer
45 Travelability determiner
49 Virtual route
50 Predetermined range of altitude map data
51 Minute Division
60 Predetermined range of travelability map data
61 Untravelable minute division
62 Travelable minute division
65 Route of travel control device
71, 72 G-G characteristic curve
81 Virtual straight route
82 Virtual steering route
83 Virtual straight-line route
P1 First parking space
P2 Second parking space

1. A vehicle configured to travel by autonomous automated driving, the vehicle comprising:
a travel control device configured to control travel of the vehicle by deciding a route to be traveled by the autonomous automated driving and controlling the travel of the vehicle by the decided route;
a vehicle external sensor provided in the vehicle and configured to make observation in a direction of advance of the vehicle; and
a travel surface information generation device for the vehicle, the travel surface information generation device being configured to generate information regarding a travel surface in the direction of advance of the vehicle, using one or both of information by the vehicle external sensor and information regarding map data acquirable for the vehicle, wherein
the travel surface information generation device is configured to perform
acquisition processing of acquiring the information by the vehicle external sensor and the information regarding the map data,
altitude map generation processing of generating, for each minute division, unevenness information regarding the travel surface in the direction of advance based on the information acquired in the acquisition processing, to generate altitude map data including the unevenness information for each minute division regarding the travel surface in the direction of advance, from the generated unevenness information regarding the travel surface,
determination processing of determining, with respect to the unevenness information for each minute division included in the altitude map data, travelability or untravelability for the vehicle of the travel surface regarding which the unevenness information regarding the travel surface is generated for each minute division in the altitude map generation processing, using one or both of specification information regarding the vehicle and information regarding a travel state of the vehicle, and
travelability map generation processing of generating, based on a determination result of the determination processing, travelability map data in which the unevenness information for each minute division in the altitude map data is replaced with the determination result of the travelability or the untravelability for each minute division, and
the travel control device is configured to
decide the route to travel on the travel surface in the direction of advance, to allow the vehicle to travel while giving priority to whichever minute division is considered to be travelable in the travelability map data over whichever minute division is considered to be untravelable in the travelability map data, to control the travel of the vehicle by the decided route.

212. The vehicle configured to travel by the autonomous automated driving according to claim 1, wherein
in the determination processing, the travel surface information generation device is configured to
select, from virtual routes to travel through the minute divisions included in the altitude map data, a virtual route to travel through each of the minute divisions,
calculate a posture of the vehicle when traveling the minute division by the selected virtual route, and
determine whether the posture of the vehicle causes a rollover when traveling through each of the minute divisions, and
in the travelability map generation processing, the travel surface information generation device is configured to
generate the travelability map data, to consider the minute division with the rollover of the vehicle to be untravelable, and to consider the minute division without the rollover of the vehicle to be travelable.

3. The vehicle configured to travel by the autonomous automated driving according to claim 2, wherein
the minute division is smaller than a size of a division of the vehicle by a number of wheels of the vehicle and larger in size than a ground plane of each of the wheels.

4. The vehicle configured to travel by the autonomous automated driving according to claim 3, wherein
the virtual routes comprise a virtual straight route that allows the vehicle to travel straight along the route and virtual steering routes that allow the vehicle to turn left or right from the virtual straight route, and
in the determination processing, the travel surface information generation device is configured to
acquire the travel state of the vehicle as travel reference information, and calculate the posture of the vehicle with the wheels of the vehicle placed on the respective minute divisions when the vehicle travels along the virtual straight route and each of the virtual steering routes while traveling after the travel reference information, and
determine whether the posture of the vehicle causes the rollover.

5. The vehicle configured to travel by the autonomous automated driving according to claim 4, wherein
in the determination processing, the travel surface information generation device is configured to
determine that each of the minute divisions is travelable in a first case where the posture of the vehicle with the wheels of the vehicle placed on the respective minute divisions when the vehicle travels along the virtual straight route and each of the virtual steering routes while traveling after the travel reference information is equal to or smaller than a rollover limit of the vehicle, and in a second case where an acceleration rate of the vehicle in each of the minute divisions when the vehicle travels by each of the virtual routes while traveling after the travel reference information is equal to or smaller than a cornering limit of the vehicle, and
determine that each of the minute divisions is untravelable when either the first case or the second case is unestablished.

6. The vehicle configured to travel by the autonomous automated driving according to claim 3, wherein
the virtual routes comprise virtual straight-line routes that allow the vehicle to travel along a direction of arrangement of the minute divisions in the altitude map data, and
in the determination processing, the travel surface information generation device is configured to
acquire the travel state of the vehicle as travel reference information and determine whether the vehicle rolls over in each of the minute divisions, based on the posture of the vehicle with the wheels of the vehicle placed on the respective minute divisions when the vehicle travels through each of the minute divisions while traveling after the travel reference information.

7. The vehicle configured to travel by the autonomous automated driving according to claim 6, wherein
in the determination processing, the travel surface information generation device is configured to
calculate the posture of the vehicle in a first case where the wheel on right side of the vehicle passes through each of the minute divisions, and calculate the posture of the vehicle in a second case where the wheel on left side of the vehicle passes through each of the minute divisions,
determine that each of the minute divisions is untravelable when determining that the vehicle is not equal to or smaller than a rollover limit in both the first case and the second case, and
determine that each of the minute divisions is travelable when determining that the vehicle is not equal to or smaller than the rollover limit in one or both of the first case and the second case.

8. The vehicle configured to travel by the autonomous automated driving according to claim 1, wherein
in the altitude map generation processing, the travel surface information generation device is configured to
acquire, together with a shape, a width, or a travelable range of a road in the direction of advance, an inclination angle of the road or unevenness information regarding the road or surroundings of the road, from the map data, and
generate three-dimensional unevenness information regarding the travel surface based on the acquired information, in association with each of the minute divisions, to generate the altitude map data including the unevenness information for each minute division regarding the travel surface in the direction of advance.

919. The vehicle configured to travel by the autonomous automated driving according to claim 1, wherein
in the altitude map generation processing, the travel surface information generation device is configured to
generate, together with a shape, a width, or a travelable range of the travel surface in the direction of advance of the vehicle, three-dimensional unevenness information regarding the travel surface, based on detection information by the vehicle external sensor regarding the direction of advance, the three-dimensional unevenness information regarding the travel surface including an inclination angle of the travel surface, or unevenness information regarding the travel surface and surroundings of the travel surface, and
associate the three-dimensional unevenness information regarding the travel surface with each of the minute divisions, to generate the altitude map data including the unevenness information for each minute division regarding the travel surface in the direction of advance.

10. The vehicle configured to travel by the autonomous automated driving according to claim 2, wherein
in the altitude map generation processing, the travel surface information generation device is configured to
acquire, together with a shape, a width, or a travelable range of a road in the direction of advance, an inclination angle of the road or unevenness information regarding the road or surroundings of the road, from the map data, and
generate three-dimensional unevenness information regarding the travel surface based on the acquired information, in association with each of the minute divisions, to generate the altitude map data including the unevenness information for each minute division regarding the travel surface in the direction of advance.

11. The vehicle configured to travel by the autonomous automated driving according to claim 3, wherein
in the altitude map generation processing, the travel surface information generation device is configured to
acquire, together with a shape, a width, or a travelable range of a road in the direction of advance, an inclination angle of the road or unevenness information regarding the road or surroundings of the road, from the map data, and
generate three-dimensional unevenness information regarding the travel surface based on the acquired information, in association with each of the minute divisions, to generate the altitude map data including the unevenness information for each minute division regarding the travel surface in the direction of advance.

12. The vehicle configured to travel by the autonomous automated driving according to claim 4, wherein
in the altitude map generation processing, the travel surface information generation device is configured to
acquire, together with a shape, a width, or a travelable range of a road in the direction of advance, an inclination angle of the road or unevenness information regarding the road or surroundings of the road, from the map data, and
generate three-dimensional unevenness information regarding the travel surface based on the acquired information, in association with each of the minute divisions, to generate the altitude map data including the unevenness information for each minute division regarding the travel surface in the direction of advance.

13. The vehicle configured to travel by the autonomous automated driving according to claim 5, wherein
in the altitude map generation processing, the travel surface information generation device is configured to
acquire, together with a shape, a width, or a travelable range of a road in the direction of advance, an inclination angle of the road or unevenness information regarding the road or surroundings of the road, from the map data, and
generate three-dimensional unevenness information regarding the travel surface based on the acquired information, in association with each of the minute divisions, to generate the altitude map data including the unevenness information for each minute division regarding the travel surface in the direction of advance.

14. The vehicle configured to travel by the autonomous automated driving according to claim 6, wherein
in the altitude map generation processing, the travel surface information generation device is configured to
acquire, together with a shape, a width, or a travelable range of a road in the direction of advance, an inclination angle of the road or unevenness information regarding the road or surroundings of the road, from the map data, and
generate three-dimensional unevenness information regarding the travel surface based on the acquired information, in association with each of the minute divisions, to generate the altitude map data including the unevenness information for each minute division regarding the travel surface in the direction of advance.

15. The vehicle configured to travel by the autonomous automated driving according to claim 2, wherein
in the altitude map generation processing, the travel surface information generation device is configured to
generate, together with a shape, a width, or a travelable range of the travel surface in the direction of advance of the vehicle, three-dimensional unevenness information regarding the travel surface, based on detection information by the vehicle external sensor regarding the direction of advance, the three-dimensional unevenness information regarding the travel surface including an inclination angle of the travel surface, or unevenness information regarding the travel surface and surroundings of the travel surface, and
associate the three-dimensional unevenness information regarding the travel surface with each of the minute divisions, to generate the altitude map data including the unevenness information for each minute division regarding the travel surface in the direction of advance.

16. The vehicle configured to travel by the autonomous automated driving according to claim 3, wherein
in the altitude map generation processing, the travel surface information generation device is configured to
generate, together with a shape, a width, or a travelable range of the travel surface in the direction of advance of the vehicle, three-dimensional unevenness information regarding the travel surface, based on detection information by the vehicle external sensor regarding the direction of advance, the three-dimensional unevenness information regarding the travel surface including an inclination angle of the travel surface, or unevenness information regarding the travel surface and surroundings of the travel surface, and
associate the three-dimensional unevenness information regarding the travel surface with each of the minute divisions, to generate the altitude map data including the unevenness information for each minute division regarding the travel surface in the direction of advance.

17. The vehicle configured to travel by the autonomous automated driving according to claim 4, wherein
in the altitude map generation processing, the travel surface information generation device is configured to
generate, together with a shape, a width, or a travelable range of the travel surface in the direction of advance of the vehicle, three-dimensional unevenness information regarding the travel surface, based on detection information by the vehicle external sensor regarding the direction of advance, the three-dimensional unevenness information regarding the travel surface including an inclination angle of the travel surface, or unevenness information regarding the travel surface and surroundings of the travel surface, and
associate the three-dimensional unevenness information regarding the travel surface with each of the minute divisions, to generate the altitude map data including the unevenness information for each minute division regarding the travel surface in the direction of advance.

18. The vehicle configured to travel by the autonomous automated driving according to claim 5, wherein
in the altitude map generation processing, the travel surface information generation device is configured to
generate, together with a shape, a width, or a travelable range of the travel surface in the direction of advance of the vehicle, three-dimensional unevenness information regarding the travel surface, based on detection information by the vehicle external sensor regarding the direction of advance, the three-dimensional unevenness information regarding the travel surface including an inclination angle of the travel surface, or unevenness information regarding the travel surface and surroundings of the travel surface, and
associate the three-dimensional unevenness information regarding the travel surface with each of the minute divisions, to generate the altitude map data including the unevenness information for each minute division regarding the travel surface in the direction of advance.

19. The vehicle configured to travel by the autonomous automated driving according to claim 6, wherein
in the altitude map generation processing, the travel surface information generation device is configured to
generate, together with a shape, a width, or a travelable range of the travel surface in the direction of advance of the vehicle, three-dimensional unevenness information regarding the travel surface, based on detection information by the vehicle external sensor regarding the direction of advance, the three-dimensional unevenness information regarding the travel surface including an inclination angle of the travel surface, or unevenness information regarding the travel surface and surroundings of the travel surface, and
associate the three-dimensional unevenness information regarding the travel surface with each of the minute divisions, to generate the altitude map data including the unevenness information for each minute division regarding the travel surface in the direction of advance.
